(19) United States
(12) Patent Application Publication
(10) Pub. No.: US 2025/0317253 A1
(43) Pub. Date: Oct. 9, 2025

(54) SRS MEASUREMENT ACCURACY

(71) Applicant: Samsung Electronics Co., Ltd., Suwon-si (KR)

(72) Inventors: Md. Saifur Rahman, Plano, TX (US); Eko Onggosanusi, Coppell, TX (US)

(21) Appl. No.: 19/094,675

(22) Filed: Mar. 28, 2025

Related U.S. Application Data
(60) Provisional application No. 63/631,919, filed on Apr. 9, 2024.

(51) Int. Cl. H04L 5/00; H04B 7/06; H04W 24/10

(52) U.S. Cl. CPC H04L 5/0051; H04B 7/0626; H04W 24/10

(57) ABSTRACT

Apparatuses and methods for improving sounding reference signal (SRS) measurement accuracy. A method performed by a user equipment (UE) includes receiving first information about transmission of a SRS in n slots, where n≥2, receiving second information about a report that is linked with transmission of the SRS in the n slots, and transmitting the SRS based on the first information in the n slots. The method further includes, based on the second information, determining a value of a quantity indicating a mismatch between transmission of the SRS in the n slots and transmitting the report including at least one indication representing the value of the quantity indicating the mismatch.

### CROSS-REFERENCE TO RELATED AND CLAIM OF PRIORITY

The present application claims priority under 35 U.S.C. § 119(e) to U.S. Provisional Patent Application No. 63/631,919 filed on Apr. 9, 2024, which are hereby incorporated by reference in their entirety.

### TECHNICAL FIELD

The present disclosure relates generally to wireless communication systems and, more specifically, the present disclosure is related to apparatuses and methods for improving sounding reference signal (SRS) measurement accuracy.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to improving SRS measurement accuracy.

In one embodiment, a user equipment (UE) is provided. The UE includes a transceiver configured to receive first information about transmission of a SRS in n slots, where n≥2, receive second information about a report that is linked with transmission of the SRS in the n slots, and transmit the SRS based on the first information in the n slots. The UE further includes a processor operably coupled to the transceiver. The processor is configured to, based on the second information, determine a value of a quantity indicating a mismatch between transmission of the SRS in the n slots. The transceiver is further configured to transmit the report including at least one indication representing the value of the quantity indicating the mismatch.

In another embodiment, a base station (BS) is provided. The BS includes a processor and a transceiver operably coupled to the processor. The transceiver is configured to transmit, to a UE, first information about transmission of a SRS in n slots, where n≥2; transmit second information about a report that is linked with transmission of the SRS in the n slots; receive the SRS based on the first information in the n slots; and receive the report including at least one indication representing a value of a quantity indicating a mismatch between the SRS in the n slots. The report is based on the second information.

In yet another embodiment, a method performed by a UE is provided. The method includes receiving first information about transmission of a SRS in n slots, where n≥2, receiving second information about a report that is linked with transmission of the SRS in the n slots, and transmitting the SRS based on the first information in the n slots. The method further includes, based on the second information, determining a value of a quantity indicating a mismatch between transmission of the SRS in the n slots and transmitting the report including at least one indication representing the value of the quantity indicating the mismatch.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure;

FIG. 10 illustrates a diagram of example radio access network (RAN) configurations according to embodiments of the present disclosure;

FIG. 11 illustrates an example of a fully digital transmitter structure for beamforming according to embodiments of the present disclosure;

FIG. 12 illustrates a diagram of example functional split points/options according to embodiments of the present disclosure;

FIG. 13 illustrates a flowchart of an example BS procedure for downlink precoding according to embodiments of the present disclosure;

FIG. 14 illustrates a diagram of an example transmit/receive switch according to embodiments of the present disclosure;

FIG. 15 illustrates a diagram of an example antenna port layout according to embodiments of the present disclosure;

FIG. 16 illustrates a timeline of example spatial-domain (SD) units and frequency-domain (FD) units according to embodiments of the present disclosure;

FIG. 17 illustrates a diagram of example sounding reference signal (SRS) port information according to embodiments of the present disclosure;

FIG. 18 illustrates a diagram of an example trigger for aperiodic (AP) SRS transmission occasions according to embodiments of the present disclosure;

FIG. 19 illustrates a diagram of example SRS transmission configurations according to embodiments of the present disclosure;

FIG. 20 illustrates a diagram of an example port group architecture according to embodiments of the present disclosure;

FIG. 21 illustrates a diagram of example co-located and non-co-located ports according to embodiments of the present disclosure; and

FIG. 22 illustrates an example method 2200 performed by a UE in a wireless communication system according to embodiments of the present disclosure.

### DETAILED DESCRIPTION

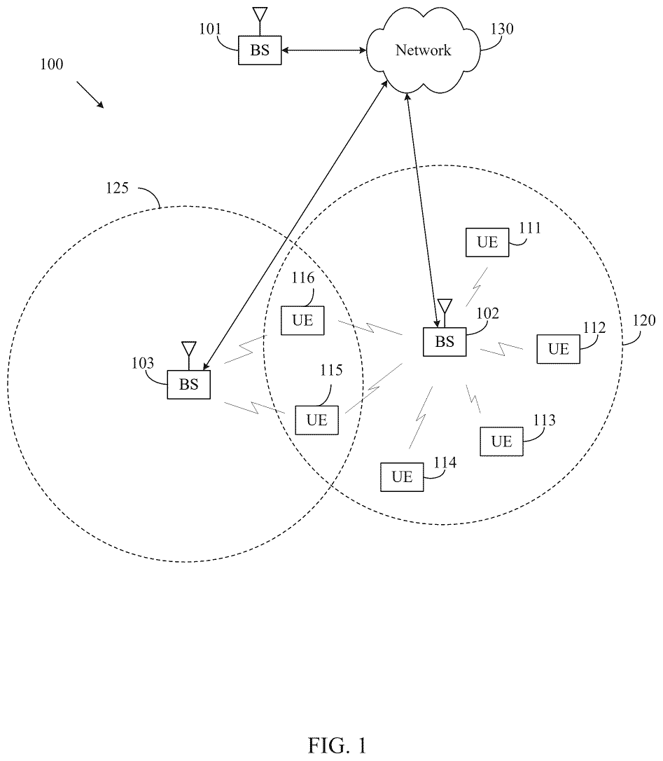

FIGS. 1-22 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

In the 5G system, Hybrid frequency shift keying (FSK) and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1]3GPP TS 36.211 v18.0.0, “E-UTRA, Physical channels and modulation;” [REF 2]3GPP TS 36.212 v18.0.0, “E-UTRA, Multiplexing and Channel coding;” [REF 3]3GPP TS 36.213 v18.0.0, “E-UTRA, Physical Layer Procedures;” [REF 4]3GPP TS 36.321 v18.0.0, “E-UTRA, Medium Access Control (MAC) protocol specification;” [REF 5]3GPP TS 36.331 v18.0.0, “E-UTRA, Radio Resource Control (RRC) Protocol Specification;” [REF 6]3GPP TS 38.211 v18.0.0, “E-UTRA, NR, Physical channels and modulation;” [REF 7]3GPP TS 38.212 v18.0.0, “E-UTRA, NR, Multiplexing and Channel coding;” [REF 8]3GPP TS 38.213 v18.0.0, “E-UTRA, NR, Physical layer procedures for control;” [REF 9]3GPP TS 38.214 v18.0.0, “E-UTRA, NR, Physical layer procedures for data;” [REF 10]3GPP TS 38.321 v18.0.0, “E-UTRA, NR, Medium Access Control (MAC) protocol specification;” [REF 11]3GPP TS 38.331 v18.0.0, “E-UTRA, NR, Radio Resource Control (RRC) Protocol Specification;” and [REF 12]O-RAN.WG4.CONF.0-R003-v09.00, “O-RAN Working Group 4 (Fronthaul Working Group).

FIGS. 1-21 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for improving SRS measurement accuracy. In certain embodiments, one or more of the BSs 101-103 include circuitry, programing, or a combination thereof to support improving SRS measurement accuracy.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

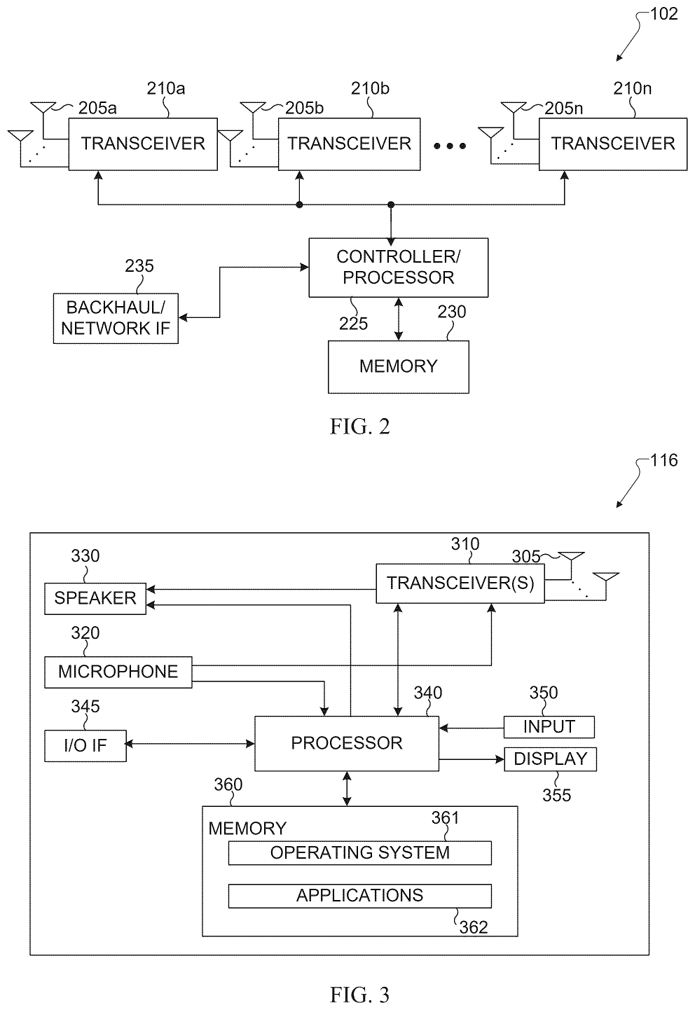

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for improving SRS measurement accuracy. Any of a wide variety of other functions could be supported in the gNB 102 by the controller/processor 225.

The controller/processor 225 is also capable of executing programs and other processes resident in the memory 230, such as processes to support improving SRS measurement accuracy. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of uplink (UL) channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for improving SRS measurement accuracy as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

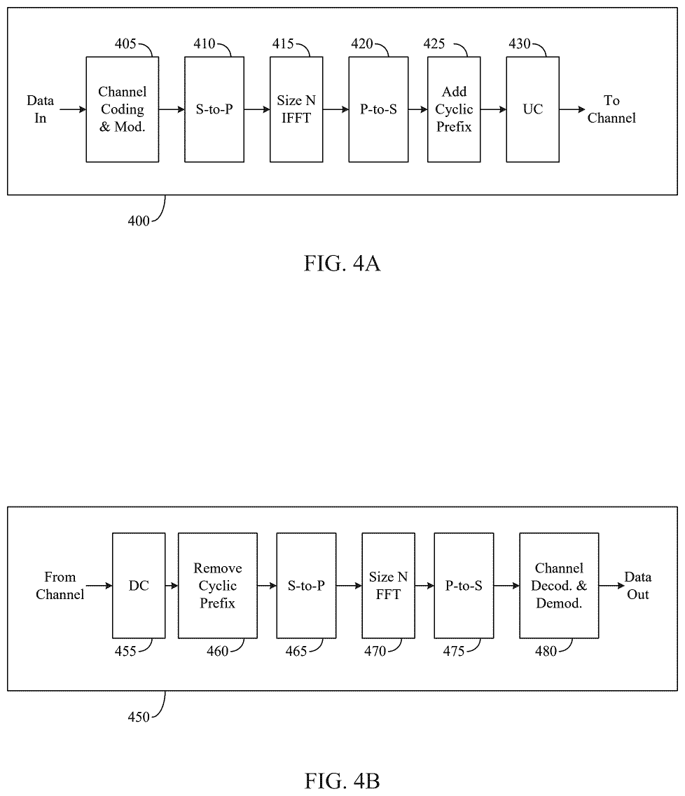

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured for improving SRS measurement accuracy as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

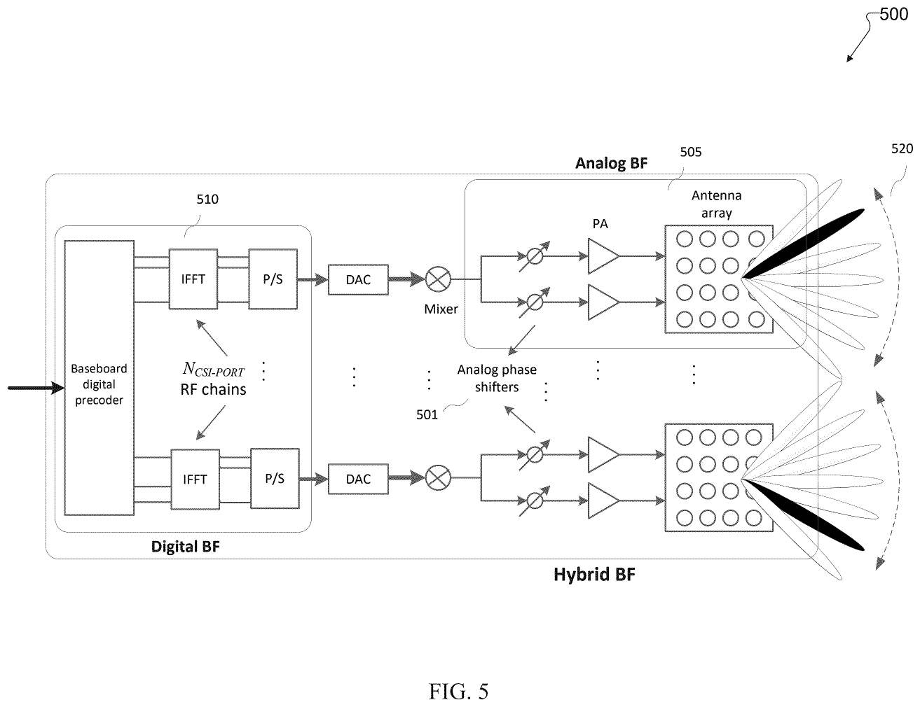

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

The present disclosure relates generally to wireless communication systems and, more specifically, to improve accuracy of channel measurement in next generation of MIMO systems.

A communication system includes a DownLink (DL) that conveys signals from transmission points such as Base Stations (BSs) or NodeBs to User Equipments (UEs) and an UpLink (UL) that conveys signals from UEs to reception points such as NodeBs. A UE, also commonly referred to as a terminal or a mobile station, may be fixed or mobile and may be a cellular phone, a personal computer device, or an automated device. An eNodeB, which is generally a fixed station, may also be referred to as an access point or other equivalent terminology. For LTE systems, a NodeB is often referred as an eNodeB (eNB). For 5G NR systems, a NodeB is often referred as an gNodeB (gNB).

In a communication system, such as LTE, 5G NR, or a next-generation system (e.g. 6G), DL signals can include data signals conveying information content, control signals conveying DL Control Information (DCI), and Reference Signals (RS) that are also known as pilot signals. An eNB/gNB transmits data information through a Physical DL Shared CHannel (PDSCH). An eNB/gNB transmits DCI through a Physical DL Control CHannel (PDCCH). An eNB/gNB transmits one or more of multiple types of RS including a Channel State Information RS (CSI-RS), or a DeModulation RS (DMRS). An eNB/gNB may transmit a CSI-RS with a density in the time and/or frequency domain for the UE to perform channel measurements. DMRS can be transmitted only in the BW of a respective PDSCH and a UE can use the DMRS to demodulate data or control information in a PDSCH or a PDCCH, respectively. A transmission time interval for DL channels is referred to as a subframe or a slot, comprise multiple (e.g. 14) OFDM symbols, and can have, for example, a duration of x millisecond, where x may depend on the subcarrier spacing (SCS). For example, x=1 for SCS=15 kHz.

DL signals also include transmission of a logical channel that carries system control information. A broadcast control channel (BCCH) is mapped to either a transport channel referred to as a Broadcast CHannel (BCH) when it conveys a Master Information Block (MIB) or to a DL Shared CHannel (DL-SCH) when it conveys a System Information Block (SIB). Most system information is included in different SIBs that are transmitted using DL-SCH. A presence of system information on a DL-SCH in a subframe (or slot) can be indicated by a transmission of a corresponding PDCCH conveying a codeword with a cyclic redundancy check (CRC) scrambled with a special System Information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe (or slot) and a group of Physical resource blocks (PRBs). A transmission BW includes frequency resource units referred to as Resource Blocks (RBs). Each RB includes

$${N}_{s c}^{R B}$$

sub-carriers, or Resource Elements (REs), such as 12 REs. A unit of one RB over one subframe (or slot) is referred to as a PRB. A UE can be allocated M_{PDSCH} RBs for a total of

$${M}_{sc}^{P D S C H} = {M}_{P D S C H} \cdot {N}_{sc}^{R B}$$

REs for the PDSCH transmission BW.

UL signals can include data signals conveying data information, control signals conveying UL Control Information (UCI), and UL RS. UL RS includes DMRS and Sounding RS (SRS). A UE transmits DMRS only in a BW of a respective PUSCH or PUCCH. An eNB/gNB can use a DMRS to demodulate data signals or UCI signals. A UE transmits SRS to provide an eNB/gNB with an UL CSI. A UE transmits data information or UCI through a respective Physical UL Shared CHannel (PUSCH) or a Physical UL Control CHannel (PUCCH). If a UE needs to transmit data information and UCI in a same UL subframe (or slot), it may multiplex both in a PUSCH. UCI includes Hybrid Automatic Repeat reQuest ACKnowledgement (HARQ-ACK) information, indicating correct (ACK) or incorrect (NACK) detection for a data TB in a PDSCH or absence of a PDCCH detection (DTX), Scheduling Request (SR) indicating whether a UE has data in its buffer, and Channel State Information (CSI) enabling an eNB/gNB to perform link adaptation and DL precoding for PDSCH transmissions to a UE. HARQ-ACK information is also transmitted by a UE in response to a detection of a PDCCH indicating a release of semi-persistently scheduled PDSCH (see also [REF 3]).

An UL subframe can include one or multiple (e.g. 2) slots. An UL slot includes

$${N}_{s y m b}^{UL}$$

symbols for transmitting data information, UCI, DMRS, or SRS. A frequency resource unit of an UL system BW is a RB. A UE is allocated N_{RB} RBs for a total of

$${N}_{R B} \cdot {N}_{s c}^{R B}$$

REs for a transmission BW. In one example, for a PUCCH, N_{RB}=1. A last subframe (or slot) symbol can be used to multiplex SRS transmissions from one or more UEs. In one example, a number of subframe (or slot) symbols that are available for data/UCI/DMRS transmission is

$${N}_{s y m b} = 2 \cdot ( {N}_{s y m b}^{UL} - 1 ) - {N}_{S R S} ,$$

where N_{SRS}=1 if a last subframe (or slot) symbol is used to transmit SRS and N_{SRS}=0 otherwise.

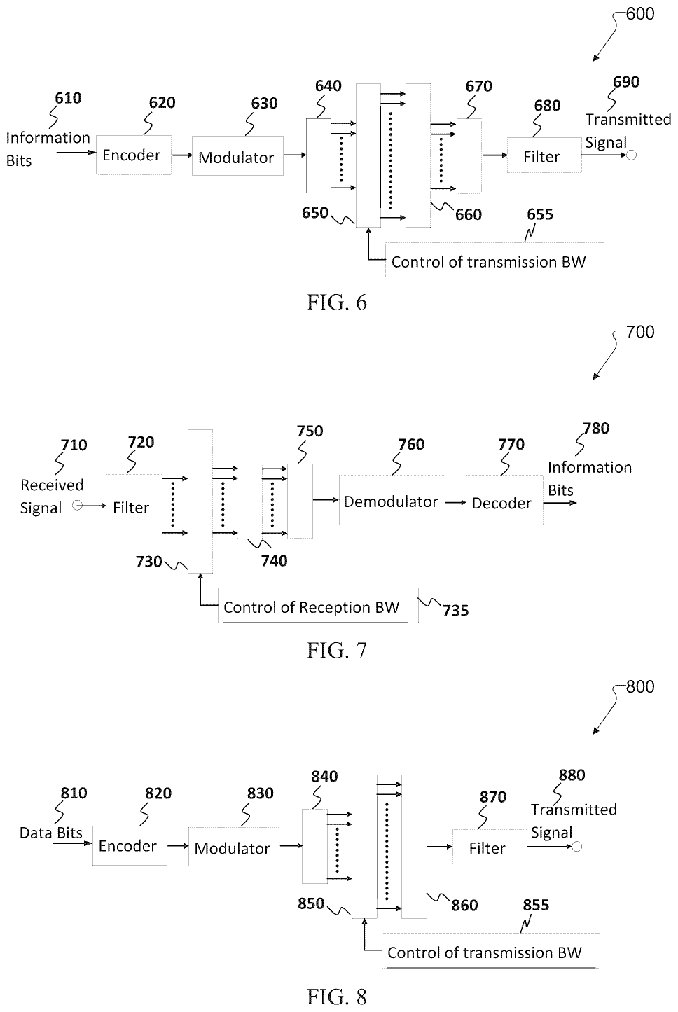

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a DMRS or a CRS (not shown), and a decoder 770, such as a turbo decoder, decodes the demodulated data to provide an estimate of the information data bits 780. Additional functionalities such as time-windowing, cyclic prefix removal, de-scrambling, channel estimation, and de-interleaving are not shown for brevity.

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

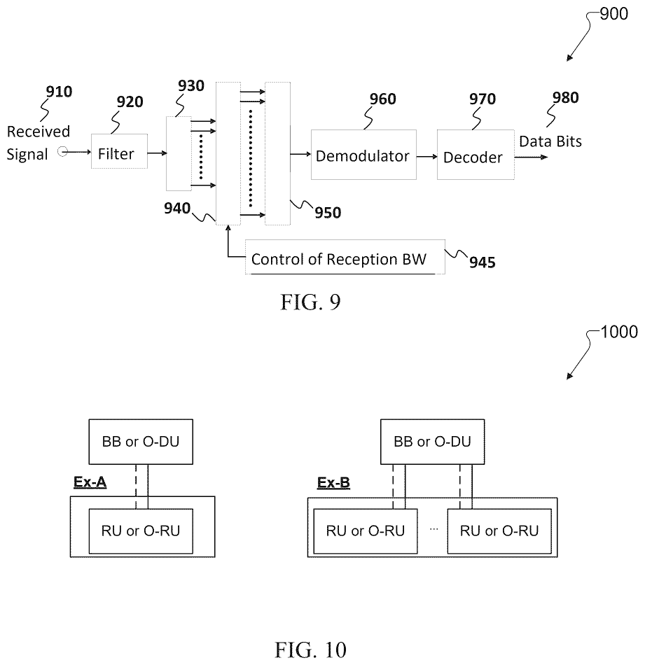

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies a FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DMRS (not shown), a decoder 970, such as a turbo decoder, decodes the demodulated data to provide an estimate of the information data bits 980.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown in Table 1 herein. Whenever the FR2 is referred, both FR2-1 and FR2-2 frequency sub-ranges shall be evaluated, unless otherwise stated.

TABLE 1
Definition of frequency ranges

| | |
|---|---|
| Frequency range designation | Corresponding frequency range |

| FR1 | | 410 MHz-7125 MHz |
|---|---|---|
| FR2 | FR2-1 | 24250 MHz-52600 MHz |
| | FR2-2 | 52600 MHz-71000 MHz |

In next generation cellular standards (e.g. 6G), in addition to FR1 and FR2, new carrier frequency bands can be evaluated, e.g. terahertz (>100 GHz) and FR3 or upper mid-band (7-24 GHz). The number of antenna ports that can be supported for these new bands is likely to be different from FR1 and FR2. In particular, for 7-15 GHz band, the max number of antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (may be non-co-located, hence geographically separated) TRPs or O-RUs within a cellular region can be the main scenario of interest, due to which the number of CSI-RS antenna ports for MIMO can be even larger (e.g. up to 256).

A (spatial or digital) precoding/beamforming can be used across these large number of antenna ports in order to achieve MIMO gains. Depending on the carrier frequency, and the feasibility of RF/HW-related components, the (spatial) precoding/beamforming can be fully digital or hybrid analog-digital. In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across antenna ports is feasible.

In a hybrid analog-digital beamforming, analog beamforming corresponds to a ‘dynamic/varying’ virtualization of multiple antenna elements to obtain one antenna port (or antenna panel). Although the number of antenna elements can be larger for a given form factor, the number of antenna ports—which can correspond to the number of digitally precoded ports—tends to be limited due to hardware constraints (such as the feasibility to install a large number of ADCs/DACs at mmWave frequencies) as illustrated in FIG. 5. In this case, one port is mapped onto a large number of antenna elements which can be controlled by a bank of analog phase shifters 501. One port can then correspond to one sub-array which produces a narrow analog beam through analog beamforming 505. This analog beam can be configured to sweep across a wider range of angles (520) by varying the phase shifter bank across symbols or subframes (or slots). The number of sub-arrays (equal to the number of RF chains) is the same as the number of antenna ports N_{PORT}. A digital beamforming unit 510 performs a linear combination across N_{PORT} analog beams to further increase precoding gain. While analog beams are wideband (hence not frequency-selective), digital precoding can be varied across frequency sub-bands or resource blocks. Receiver operation can be conceived analogously.

As described herein, the NW topology/architecture is likely to be more and more distributed in future (e.g. 6G) due to reasons explained herein (e.g. use cases, HW requirements, antenna form factors, mobility etc.). In this disclosure, such a distributed system is referred to as a DMIMO or multiple TRP (mTRP) system (multiple antenna port groups, which can be non-co-located). The transmission in such a system can be coherent joint transmission (CJT), i.e., a layer can be transmitted across/using multiple TRPs, or non-coherent joint transmission (NCJT). Due to distributed nature of operation, the groups of antenna ports (or TRPs) need to be calibrated/synchronized by compensating for the non-idealities such as time/frequency/phase offsets non-ideal backhaul across TRPs, due to HW impairments, different delay profiles, and Doppler profile (in high-speed scenarios) associated with different TRPs

In one example, a TRP can be functionally equivalent to (hence can be replaced with) or is interchangeable with one of more of the following: an antenna, or an antenna group (multiple antennae), an antenna port, an antenna port group (multiple ports), a CSI-RS resource, multiple CSI-RS resources, a CSI-RS resource set, multiple CSI-RS resource sets, an antenna panel, multiple antenna panels, a Tx-Rx entity, a (analog) beam, a (analog) beam group, a cell, a cell group.

FIG. 10 illustrates a diagram of example RAN configurations 1000 according to embodiments of the present disclosure. For example, RAN configurations 1000 can be implemented by the BS 103 of FIG. 1. This example is for illustration only and other embodiments can be used without departing from the scope of the present disclosure.

In an O-RAN, a TRP can be functionally equivalent to (hence can be replaced with) or is interchangeable with one of more of the following:
One RU or O-RU: a logical node that includes a subset of the eNB/gNB functions (e.g. as listed in clause 4.2 split option 7-2x)
More than one RUs or O-RUs
One or more than one RUs or O-RUs

Two examples are shown in FIG. 10.

The following are defined in [REF12] and [REF13].

| | |
|---|---|
| O-CU | O-RAN Central Unit - a logical node hosting PDCP, RRC, |
| | SDAP and other control functions |
| O-DU | O-RAN Distributed Unit: a logical node hosting RLC/MAC/ |
| | High-PHY layers based on a lower layer functional split. O-DU |
| | in addition hosts an M-Plane instance. |
| O-RU | O-RAN Radio Unit: a logical node hosting Low-PHY layer and |
| | RF processing based on a lower layer functional split. This is |
| | similar to 3GPP's “TRP” or “RRH” but more specific in |
| | including the Low-PHY layer (FFT/iFFT, PRACH extraction). |
| | O-RU in addition hosts M-Plane instance. |

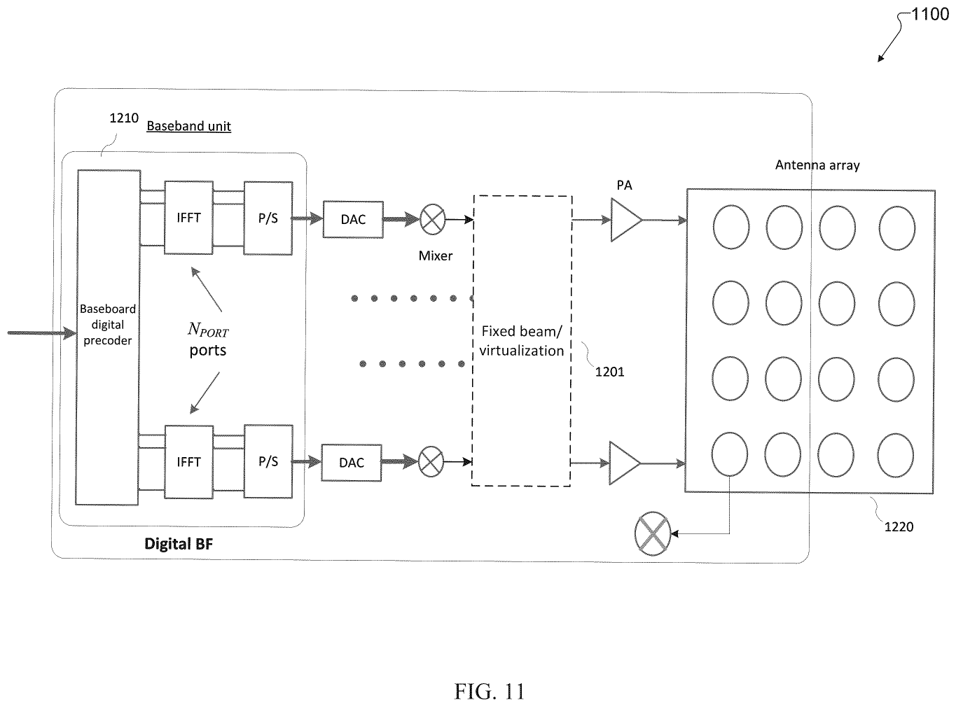

FIG. 11 illustrates an example of a fully digital transmitter structure 1100 for beamforming according to embodiments of the present disclosure. For example, fully digital transmitter structure 1100 can be implemented in the BS 102 of FIG. 2. This example is for illustration only and other embodiments can be used without departing from the scope of the present disclosure.

The fully digital transmitter structure 1200 includes a digital beamformer 1210, a fixed beam/virtualization 1201, and antenna array angles 1220.

A NW can be built upon a spatial resource entity, say X (e.g. TRP or O-RU). For FR1/FR3, the spatial entity X comprises one or more antenna ports that are fully-digital (i.e. each antenna port is driven by a dedicated baseband processing chain), as shown in FIG. 11; and in FR2, the entity X comprises one or more antenna panels (sub-arrays), each comprising one (or two) antenna ports that is (are) controlled by analog phase shifters that result in an analog beam (pointing in certain spatial direction), as shown in FIG. 5. An antenna port in FR1/FR3 can also be beam-formed (aka virtualization); however, such a beamforming (BF) is generally static (non-adaptive, hence does not requiring measurement and reporting). In FR2, due to large propagation loss at mmWave frequencies, each antenna panel requires dynamic frequent update of the analog BF, which is often based on (analog) beam measurement and reporting.

A communication between NW and a user can broadly be based on: (A1) NW resources, and (A2) signaling components, where the former corresponds to spatial-domain, frequency-domain, and time-domain (SD, FD, TD) resources allocated to the user for the communication, and the latter corresponds to components that are signaled over the NW resources. The SD resources can be based on a single TRP/O-RU (sTRP) or multiple TRPs/O-RUs (mTRP), where mTRP can be (B1) co-located at a site/location or (B2) non-co-located/distributed at multiple sites/locations, where the latter corresponds to a distributed SD resource, hence the corresponding communication hypothesis can be (C1) non-coherent joint transmission (NCJT) where a data stream (layer) is transmitted from one of the mTRPs, or (C2) coherent JT (CJT), where a data stream (layer) can be transmitted from multiple of the mTRPs. The FD resources can comprise a set of PRBs, and the TD resources can comprise one or multiple time slots (i.e., 1 slot=N_{sym} consecutive symbols).

The signaling components include signaling associated with (D1) measurement, (D2) channel state information (CSI) report, and (D3) DL reception or UL transmission.

For (D1), the user measures channel measurement RSs (CMRs), e.g. CSI-RS, to estimate the channel condition between the sTRP/mTRP and the user. In case of sTRP, the user can measure a set comprising one or multiple DL measurement ports (or resources). For mTRP, the measurement ports (or resources) can be (E1) one set comprising one group of ports (or resources) per TRP, or (E2) one set per TRP. The user can also measure the interference based on interference measurement RSs (IMRs). A CMR can correspond to an analog beam, and can be repeated in multiple symbols for determining user's analog beam. For UL, the user transmits UL CMRs, e.g. SRS, for the NW to perform UL channel measurement and UL CSI acquisition.

For (D2), the user, based on the measurement, determines the CSI and reports it to the NW, where the CSI can be (F1) (analog) beam-related CSI, or (F2) (digital) non-beam-related CSI. For (F1), the user can determine one or multiple pairs (indicator, metric), where the indicator indicates a CMR and the metric indicates a (beam) quality (e.g. reference signal received power (RSRP), signal-to-interference-plus-noise ratio (SINR)).

For (F2), a low-resolution (Type-I) CSI and a high-resolution (Type-II) CSI can be supported. The Type-I CSI can be based on L=1 DFT SD vector per layer. The Type-II CSI is based on a weighted linear combination L>1 SD DFT vectors where the weights correspond to coefficients. The FD DFT vectors can also be introduced to reduce the CSI feedback overhead by compressing channel coefficients in both SD and FD. Type-I or Type-II CSI can also be extended to support NCJT or CJT CSI from mTRP or/and for high/medium user velocities by exploiting time-domain correlation or Doppler-domain information.

A unified transmission configuration indication (uTCI) framework supports signaling of a unified TCI state to a user, where the unified TCI state can be a DL-TCI, an UL-TCI or a joint TCI (J-TCI) state, where a DL-TCI state is applied for receiving DL channels/signals, an UL-TCI state is applied for transmitting UL channels/signals, and a J-TCI state is applied for both DL and UL channels/signals. The uTCI framework is designed to support DL receptions and UL transmissions (i) with a joint (common) beam indication for DL and UL by leveraging beam correspondence (reciprocity between DL and UL), and (ii) with separate beam indications for DL and UL, for example to mitigate maximum permissible exposure, where the beam direction of an UL transmission is different from the beam direction of a DL reception to avoid exposure of the human body to radiation.

The uTCI framework can support a beam-level mobility, known as inter-cell BM (ICBM). In ICBM, the user-dedicated channels can be configured to use a beam (i.e., TCI state) associated with a (non-serving) cell having a physical cell identity (PCI) that is different from the PCI of the serving cell. This allows fast beam-switch to a non-serving cell for user-dedicated channels at a lower layer without involving a higher layer and without incurring latency and overhead of handover.

The ICBM can be followed by a complete cell-switch triggered by lower layers, which is known as lower-layer triggered mobility (LTM). In LTM, the NW can acquire beam measurements, and UL timing information for target candidate cells before cell-switch. The lower layers of the NW decide when to perform a cell-switch, and send a medium access control channel element (MAC CE) containing a cell-switch command (CSC) that triggers the cell-switch from a source cell to a target cell. The CSC includes beam (i.e., TCI state) and UL timing information for the user to use on the target cell. After a beam application delay, the user and the NW communicates via the target cell.

Full-duplex transmission and reception in the same channel BW or using non-contiguous intra-band carrier aggregation (CA) is a promising technology to enhance UL coverage, reduce latency and improve system capacity and to overcome limitations inherent to the use of de-facto mandated semi-static time division duplexing (TDD) UL-DL frame configurations in today's TDD deployments. In NW-side subband full-duplex (SBFD) mode, simultaneous transmissions and receptions by the NW on the same time-domain symbol on the NR carrier can occur in non-overlapping UL and DL subbands. The users with support for NW-side SBFD operation still operate in half-duplex, i.e., the user can either transmit or receive on an SBFD symbol but not transmit and receive simultaneously. An SBFD UL subband can be located in the center or at the edge of the NR carrier in FR1 or FR2-1. For CA-based SBFD in FR2-1, one component carrier (CC) can be allocated for UL transmissions whereas the remaining CCs can be used for DL transmission. NW-side self-interference cancellation (SIC) capability to enable SBFD can be realized through a combination of solutions. For example, the NW can use Tx/Rx antenna isolation on the antenna panel(s), beam steering, analog and/or digital pre-distortion, digital interference cancellation, and analog and/or digital filtering solutions.

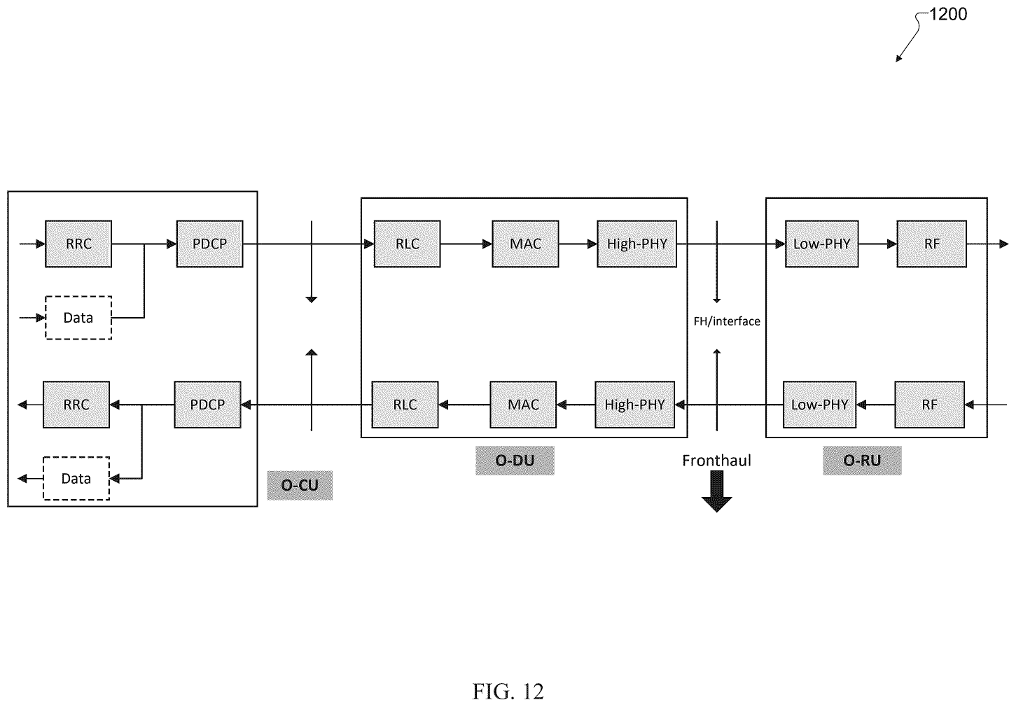

FIG. 12 illustrates a diagram of example functional split points/options 1200 according to embodiments of the present disclosure. For example, functional split points/options 1200 may be implemented by the BS 102 of FIG. 1. This example is for illustration only and other embodiments can be used without departing from the scope of the present disclosure.

As explained, the 5G NW can support several features, services, use cases, and deployment scenarios. It however also introduces too many different abstractions (for specification) of NW entities and involved signaling for components of these abstractions. A direct scaling/extension/reuse of these common up to 5G solutions for 6G will add to the complexity, which is undesired in real NW deployments. Accordingly, embodiments of the present disclosure recognize that at least two aspects need to be evaluated in next-gen MIMO systems (e.g. 6G).
(A) 3GPP PHY specification: a single band-agnostic NW entity, namely a port, and an associated QCL (or TCI state) to indicate source RS (or analog beam). For CSI, multiple ports or a port group (PG) (as a collection of ports) can be used.
(B) NW architecture as perceived in O-RAN: The functionality split among O-RAN entities for DL and UL operations, such as O-RU, O-DU, and O-CU (as described herein). An example is shown in FIG. 12. In particular, the PHY functionality split between O-DU and O-RU includes at least the following aspects.
   (B1) PHY processing:
      bit-level processing,
      symbol-level processing
   (B2) Scheduling (residing in MAC): SU-MIMO/MU-MIMO scheduling across different O-RUs or/and allocated frequency-domain resources (e.g. PRBs, precoding resource block groups (PRGs), SBs)
      Utilizing UCI carrying CSI
      If DL/UL reciprocity is feasible, also utilizing SRS-based channel measurement
   (B3) Precoder calculation at a gNB (NW side) for DL-SCH transmission:
      For SU-MIMO, precoder can simply follow the precoding matrix indicator (PMI) (calculated implying SU-MIMO hypothesis) reported by the UE, or, if DL/UL reciprocity is feasible, be calculated from the eigenvector(s) of the measured DL channels.
      For MU-MIMO, precoder needs to be calculated based on additional orthogonalization (e.g. zero-forcing beamforming (ZFBF), SLNR) among PMIs, or, if DL/UL reciprocity is feasible, the eigenvectors of the measured channels of the co-scheduled UEs

A few relevant (more-probable) candidates discussed in the O-RAN Alliance (depicted in FIG. 12) are shown in Table 2.

TABLE 2
(both DL and UL)

| | | | | | | | |
|---|---|---|---|---|---|---|---|
| | | | High- | Low- | | | |
| PDCP | RLC | MAC | PHY | PHY | RF | HLS | LLS |

| | | | | | |
|---|---|---|---|---|---|
| O-RAN¹ | O-CU: | O-DU: RLC, MAC, High- | O-RU: Low-PHY, | Y | symbol- |
| (Opt7-2x) | PDCP | PHY | RF | | level PHY |
| Opt7-3 | O-CU: | O-DU: RLC, MAC, High- | O-RU: Low-PHY, | Y | bit-level |
| | PDCP | PHY | RF | | PHY |

| | | | | |
|---|---|---|---|---|
| Opt8 | DU: RLC, MAC, PHY | RU: | Y | CPRI |

RF

O-RAN¹: [REF 12]

Cat-A, Cat-B
UL: Cat-C

The main difference between a FR1 port and a FR2 panel is that the beam/virtualization (i.e. port assignment) is fixed in the former, and it requires (a) measurement and reporting from UE and (b) a beam indication from the NW (TCI state with QCL-TypeD). It is therefore plausible to have a unified framework in which a port in FR1 and a panel in FR2 can be abstracted based on a unified, band-agnostic spatial entity, e.g. port or port group (PG), and associated QCL and coherency properties across ports or PGs (intra-/inter PG). For instance,
Port: a FR1 port and a FR2 beam/source
Port group (PG): a collection ports for CSI acquisition and DL/UL transmission

While the O-RAN Alliance is intended for 5G NR, it is expected that its framework will continue, or at most refined, for 6G. The O-RAN Alliance specifies 3 levels of functional splits—namely CU, DU, and RU—to facilitate multi-vendor inter-operability within a NW. The manner in which PHY-layer functions are split between DU and RU(s) imposes serious impact on the feasibility, performance, and complexity of different MIMO schemes—mainly due to the latency and quantization loss incurred by the O-RAN-standardized RU-DU interface.

In this sense, a “port” can be associated with a digital port in FR1/FR3 or an analog beam in FR2 (thereby abandoning the 5G association between an analog beam and a CSI-RS resource for FR2).

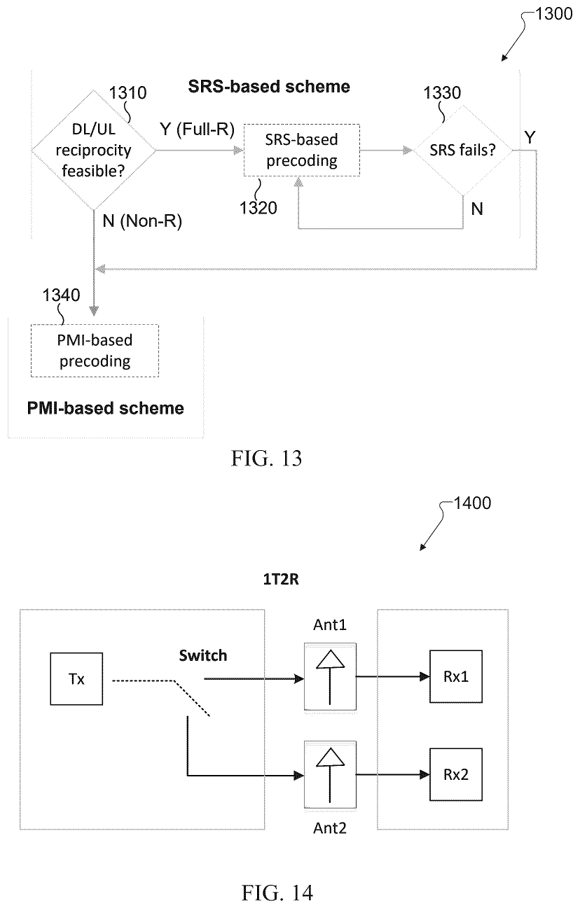

FIG. 13 illustrates a flowchart of an example BS procedure 1300 for downlink precoding according to embodiments of the present disclosure. For example, procedure 1300 can be performed by the BS 102 of FIG. 1.

The procedure begins in 1310, DL/UL reciprocity feasibility is determined. If DL/UL reciprocity is feasible, then in 1320, SRS-based precoding is performed. Otherwise, in 1340, PMI-based precoding is performed. In 1330, SRS failure is determined. If SRS does fail, then the procedure performs 1340. Otherwise, the procedure returns to 1320.

The precoding in a DL transmission scheme can be SRS-based or PMI-based, as shown in FIG. 13, where the SRS-based scheme can only use used when the DL-UL reciprocity is feasible and SRS channel measurement is feasible (i.e. UL signal-to-noise ratio (SNR) of channel measurement is not too small). The PMI-based scheme can be used regardless of reciprocity expectations.

In TDD, a common approach to acquire DL channel state information is to exploit UL channel estimation through receiving UL RSs (e.g., SRS) sent from UE. By using the channel reciprocity in TDD systems, the UL channel estimation itself can be used to infer DL channels. This favorable feature enables NW/gNB (e.g., the BS 102) to reduce the training overhead significantly. However, due to the RF impairment at transmitter and receiver, directly using the UL channels for DL channels is not accurate. This impairment exists at both NW-side and UE-side.

At the NW-side, it requires a calibration process (periodically) among receive and transmit antenna ports of the RF network. In general, NW has an on-board calibration mechanism in its own RF network to calibrate its antenna panels having a plurality of receiver/transmitter antenna ports, to enable DL/UL channel reciprocity in channel acquisition. The on-board “self” calibration mechanism can be performed via small-power RS transmission and reception from/to the RF antenna network of NW and thus it can be done by NW's implementation in a confined manner (i.e., that does not interfere with other entities). However, it becomes difficult to perform the on-board calibration in distributed MIMO systems due to the distribution of the panels/TRPs over a wide region, and thus it will require over-the-air (OTA) signaling mechanisms to calibrate receive/transmit antenna ports among multiple panels/TRPs far away in distributed MIMO. A UE-assisted calibration mechanisms can overcome the NW-side issue.

FIG. 14 illustrates a diagram of an example transmit/receive switch 1400 according to embodiments of the present disclosure. For example, transmit/receive switch 1400 can be implemented in any of the UEs 111-116 of FIG. 1. This example is for illustration only and other embodiments can be used without departing from the scope of the present disclosure.

At the UE-side, for a UE (e.g., the UE 116) with xTyR (x transmit antenna ports and y receive antenna ports), when x=y, the calibration process can be the same the on-board “self” calibration described herein, and when x<y, the UE needs to perform antenna switching for SRS transmission, which may cause the following issues in SRS-based measurement at the NW.
Issue 1: for 1T2R, as shown in FIG. 14, the Tx and Rx chains are different, the Tx includes a switch and Rx doesn't, and Tx has 1 RF chain connected to baseband (BB) unit, and Rx has 2 RF chains connected to BB unit.
Issue 2: the transmit power of the two SRS transmissions (while switching) may not be the same due to two different physical locations of the antennae on the UE, and necessary power adjustment (back-off) of one antenna (e.g. owing to other components on the UE).

Accordingly, embodiments of the present disclosure further recognize that the two issues weaken the DL-UL channel reciprocity expectation (even for TDD systems), and can lead to inaccurate SRS channel measurement at NW, which if unaddressed, can impact the DL precoding performance severely. Solutions to mitigate these issues (in order to restore TDD DL-UL channel reciprocity and reap the benefits of SRS-based DL precoding) is therefore essential, especially for FR1/FR3 in which the number of DL antenna ports can be very large (much larger than number of SRS ports).

This disclosure provides a few solutions based on a reporting of the UE assistance information to reduce the inaccuracy (or improved accuracy) of SRS channel measurement.

The present disclosure relates to next generation MIMO communication systems (e.g. adv. 5G and 6G). This disclosure, in particular, provides a UE assistance reporting to improve accuracy of SRS-based channel estimation at the NW, the estimated channel can be used for DL precoding (when DL-UL reciprocity is feasible) or UL precoding indication; and following are aspects of this disclosure:
Framework for SRS
UE assistance reporting
Measurement associated with UE assistance reporting
Signaling details

In the following, for brevity, both frequency division duplexing (FDD) and time division duplexing (TDD) are regarded as the duplex method for both DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure of disclosure covers several components which can be used in conjunction or in combination with one another, or can operate as standalone schemes.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, the following components and embodiments are applicable for UL transmission when the scheduling unit in time is either one subframe (which can include one or multiple slots) or one slot.

In the present disclosure, the frequency resolution (reporting granularity) and span (reporting bandwidth) of a reporting (e.g. CSI or UE assistance information) can be defined in terms of frequency “subbands” and “CSI reporting band” (CRB), respectively.

A subband for the reporting is defined as a set of contiguous PRBs which represents the smallest frequency unit for the reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in the reporting setting or configuration.

“A reporting band” is defined as a set/collection of subbands, either contiguous or non-contiguous, wherein the reporting is performed. For example, the reporting band can include the subbands within the system bandwidth (e.g. DL BW). This can also be termed “full-band”. Alternatively, the reporting band can include only a collection of subbands within the system bandwidth. This can also be termed “partial band”.

The term “a reporting band” is used only as an example for representing a function. Other terms such as “a reporting subband set” or “a reporting bandwidth” or bandwidth part (BWP) can also be used.

In terms of UE configuration, a UE can be configured with at least one reporting band (e.g. CSI reporting band or UE assistance information reporting band). This configuration can be semi-static (via higher-layer signaling or RRC) or dynamic (via MAC CE or L1 DL control signaling). When configured with multiple (N) CSI reporting bands (e.g. via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “wideband” or “single” reporting for the CSI reporting band with Mₙ subbands when one CSI parameter for the Mₙ subbands within the CSI reporting band. A CSI parameter is configured with “subband” for the CSI reporting band with Mₙ subbands when one CSI parameter is reported for each of the Mₙ subbands within the CSI reporting band.

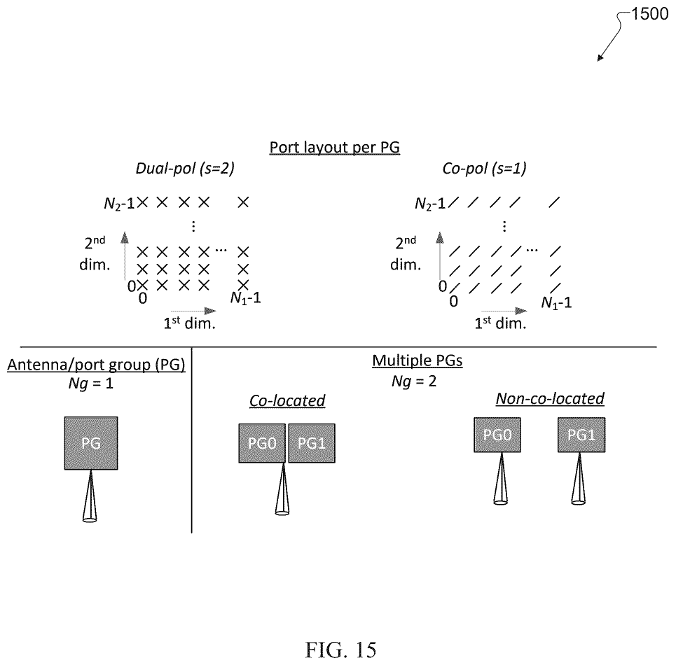

FIG. 15 illustrates a diagram of an example antenna port layout 1500 according to embodiments of the present disclosure. For example, antenna port layout 1500 can be implemented in the wireless network 100 of FIG. 1. This example is for illustration only and can be used without departing from the scope of the present disclosure.

In the following, N₁ and N₂ are the number of antenna ports with the same polarization in the first and second dimensions, respectively. For 2D antenna port layouts, N₁>1, N₂>1, and for 1D antenna port layouts N₁>1 and N₂=1 or N₂>1 and N₁=1. In the rest of the disclosure, 1D antenna port layouts with N₁>1 and N₂=1 is provided. The disclosure, however, is applicable to the other 1D port layouts with N₂>1 and N₁=1. Also, in the rest of the disclosure, N₁≥N₂. The disclosure, however, is applicable to the case when N₁<N₂, and the embodiments for N₁>N₂ apply to the case N₁<N₂ by swapping/switching (N₁, N₂) with (N₂, N₁). For a single-polarized (or co-polarized) antenna port layout, the total number of antenna ports is P_{CSIRS}=N₁N₂. And, for a dual-polarized antenna port layout, the total number of antenna ports is P_{CSIRS}=2N₁N₂. An illustration is shown in FIG. 15 where “X” represents two antenna polarizations (dual-pol, s=2) and “/” represents one antenna polarization (co-pol, s=1). In this disclosure, the term “polarization” refers to a group of antenna ports with the same polarization. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports an X is a starting antenna port number (e.g. X=3000, then antenna ports are 3000, 3001, 3002, . . . ). Unless stated otherwise, dual-polarized antenna layouts are expected in this disclosure. The embodiments (and examples) in this disclosure however are general and are applicable to single-polarized antenna layouts as well.

Let s denotes the number of antenna polarizations (or groups of antenna ports with the same polarization). Then, for co-polarized antenna ports, s=1, and for dual- or cross (X)-polarized antenna ports s=2. So, the total number of antenna ports Pₜₒₜ=sN₁N₂.

Let N_{g} be a number of ports or antenna/port groups (PGs). When there are multiple antenna/port groups (N_{g}>1), each group (g ∈ {1, . . . , N_{g}}) comprises N_{1,g} and N_{2,g} ports in two dimensions. This is illustrated in FIG. 15. Note that the antenna port layouts may be the same (N_{1,g}=N₁ and N_{2,g}=N₂) in different antenna/port groups, or they can be different across antenna/port groups. For group g, the number of antenna ports is P_{tot,g}=N_{1,g} N_{2,g} or 2N_{1,g} N_{2,g}(for co-polarized or dual-polarized respectively), i.e., P_{tot,g}=s_{g}N_{1,g}N_{2,g} where s_{g}=1 or 2.

In one example, an antenna/port group corresponds to an antenna panel. In one example, an antenna/port group corresponds to a TRP. In one example, an antenna/port group corresponds to an RRH. In one example, an antenna/port group corresponds to CSI-RS antenna ports (of a PG or non-zero power (NZP) CSI-RS resource). In one example, an antenna/port group corresponds to a subset of CSI-RS antenna ports (of a PG or NZP CSI-RS resource) (comprising multiple antenna/port groups). In one example, an antenna/port group corresponds to CSI-RS antenna ports of multiple NZP CSI-RS resources (e.g. comprising a CSI-RS resource set). In one example, an antenna/port group corresponds to SRS antenna ports (of a PG or SRS resource). In one example, an antenna/port group corresponds to a subset of SRS antenna ports (of a PG or a SRS resource) (comprising multiple antenna/port groups). In one example, an antenna/port group corresponds to SRS antenna ports of PGs or multiple SRS resources (e.g. comprising a SRS resource set).

In one example, an antenna/port group corresponds to a reconfigurable intelligent surface (RIS) in which the antenna/port group can be (re-)configured more dynamically (e.g. via MAC CE or/and DCI). For example, the number of antenna ports associated with the antenna/port group can be changed dynamically.

In one example, the antenna architecture of the MIMO system is structured. For example, the antenna structure at each PG or O-RU (or RU) is dual-polarized (single or multi-panel as shown in FIG. 15). The antenna structure at each PG or O-RU (or RU) can be the same. Or the antenna structure at an PG or O-RU (or RU) can be different from another PG or O-RU (or RU). Likewise, the number of ports at each PG or O-RU (or RU) can be the same. Or the number of ports at one PG or O-RU (or RU) can be different from another PG or O-RU (or RU).

In another example, the antenna architecture of the MIMO system is unstructured. For example, the antenna structure at one PG or O-RU (or RU) can be different from another PG or O-RU (or RU).

A structured antenna architecture is expected in the rest of the disclosure. For simplicity, each PG or O-RU (or RU) is equivalent to a panel (cf. FIG. 15), although, an PG or O-RU (or RU) can have multiple panels in practice. The disclosure however is not restrictive to a single panel expectation at each PG or O-RU (or RU), and can easily be extended (covers) the case when an PG or O-RU (or RU) has multiple antenna panels.

In one embodiment, an PG (or O-RU or RU) constitutes (or corresponds to or is equivalent to) at least one of the following:
In one example, an PG OR O-RU (OR RU) corresponds to a TRP.
In one example, an PG or O-RU (or RU) corresponds to a DL RS (e.g. CSI-RS) or UL RS (e.g. SRS). A UE is configured with K=N_{g}>1 DL or UL RSs, one per PG.
In one example, an PG or O-RU (or RU) corresponds to a DL/UL RS group, where a group comprises one or multiple DL/UL RSs. AUE is configured with K≥N_{g}>1 DL/UL RSs, and the K RSs can be partitioned into N_{g} groups. The information about the grouping can be provided together with the RS setting/configuration, or with the reporting setting/configuration.
In one example, an PG or O-RU (or RU) corresponds to a subset (or a group) of DL/UL RS ports.
In one example, an PG or O-RU (or RU) corresponds to one or more examples described herein depending on a configuration. For example, this configuration can be explicit via a parameter (e.g. an RRC parameter). Or it can be implicit.
   In one example, when implicit, it could be based on the value of K.
   In another example, the configuration could be based on the configured codebook. For example, an PG or O-RU (or RU) corresponds to a CSI-RS resource (according to one or more examples described herein) or resource group (according to one or more examples described herein) when the codebook corresponds to a decoupled codebook (modular or separate codebook for each PG or O-RU (or RU)), and an PG or O-RU (or RU) corresponds to a subset (or a group) of CSI-RS ports (according to one or more examples described herein when codebook corresponds to a coupled (joint or coherent) codebook (one joint codebook across PGs).

In one example, when PG or O-RU (or RU) maps (or corresponds to) a CSI-RS or CSI-RSs (according to one or more examples described herein), and a UE can select a subset of PGs (resources or resource groups) and report the CSI for the selected PGs (resources or resource groups), the selected PGs can be reported via an indicator. For example, the indicator can be a PGI (PG indicator) or channel quality indicator (CQI) report interval (CRI) or SRS resource indicator or a PMI (component) or a new indicator.

In one example, when PG or O-RU (or RU) maps (or corresponds to) a CSI-RS port group (according to one or more examples described herein), and a UE can select a subset of PGs (port groups) and report the CSI for the selected PGs (port groups), the selected PGs can be reported via an indicator. For example, the indicator can be a PGI or a CRI or a PMI (component) or a new indicator.

In one example, when multiple (K>1) CSI-RSs are configured for N_{g} PGs (according to one or more examples described herein), a decoupled (modular) codebook is used/configured, and when a single (K=1) CSI-RS for N_{g} PGs (according to one or more examples described herein), a joint codebook is used/configured.

In one embodiment, a UE is configured (e.g. via a higher layer) with a report, where the report is based on a channel measurement (or, optionally, interference measurement or/and a codebook). When the report is configured to be aperiodic, it is reported when triggered via a DCI field (e.g. a CSI request field) in a DCI. The DCI can be UL-related DCI (DCI format with UL grant for PUSCH) or DL-related DCI (DCI format with DL assignment for PDSCH) or a dedicated special-purpose DCI.

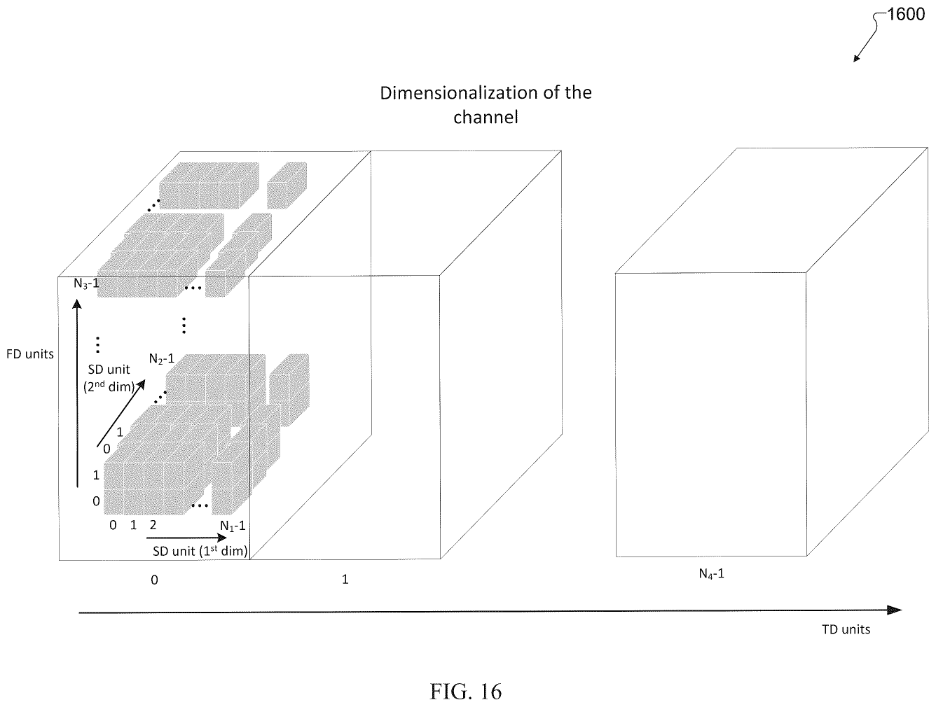

FIG. 16 illustrates a timeline 1600 of example SD units and FD units according to embodiments of the present disclosure. For example, timeline 1600 can be followed by any of the UEs 111-116 of FIG. 1. This example is for illustration only and other embodiments can be used without departing from the scope of the present disclosure.

The channel measurement can be based on K≥1 channel measurement RSs (CMRs) that are transmitted from a plurality of spatial-domain (SD) units (e.g. a SD unit=a antenna port), and are measured via a plurality of frequency-domain (FD) units (e.g. a FD unit=one or more PRBs/SBs) and via either a time-domain (TD) unit or a plurality of TD units (e.g. a TD unit=one or more time slots). In one example, a CMR can be a NZP-CSI-RS for DL channel measurement and a SRS for UL channel measurement. In case of DL-UL reciprocity, DL channel measurement can be based on UL channel measurement via SRS, and vice versa.

The report can be associated with the plurality of FD units and the plurality of TD units associated with the channel measurement. Alternatively, the report can be associated with a second set of FD units (different from the plurality of FD units associated with the channel measurement) or/and a second set of TD units (different from the plurality of TD units associated with the channel measurement). In this later case, the receiving entity (e.g. UE), based on the channel measurement, can perform prediction (interpolation or extrapolation) in the second set of FD units or/and the second set of TD units associated with the report.

An illustration of the SD units (in 1^{st} and 2^{nd} antenna dimensions), FD units, and, and TD units is shown in FIG. 16.
The first dimension is associated with the 1st antenna port dimension and comprises N₁ units,
The second dimension is associated with the 2nd antenna port dimension and comprises N₂ units,
The third dimension is associated with the frequency dimension and comprises N₃ units, and
The fourth dimension is associated with the time/Doppler dimension and comprises N₄ units.

Alternatively, the SD units, FD units, and, and TD units are as follows.
The first dimension is associated with the antenna port dimension and comprises Pₜₒₜ units,
The second dimension is associated with the frequency dimension and comprises N₃ units, and
The third dimension is associated with the time/Doppler dimension and comprises N₄ units.

The plurality of SD units can be associated with antenna ports (e.g. co-located at one site or distributed across multiple sites) comprising one or multiple antenna/port groups (i.e., N_{g}≥1), and dimensionalizes the spatial-domain profile of the channel measurement.

When K=1, there is one CMR comprising Pₜₒₜ antenna ports.
When N_{g}=1, there is one PG comprising Pₜₒₜ ports, and the report is based on the channel measurement from the one PG.
When N_{g}>1, there are multiple PGs, and the report is based on the channel measurement from/across the multiple PGs.

When K>1, there are multiple CMRs, and the report is based on the channel measurement across the multiple CMRs. In one example, a CMR corresponds to an PG (one-to-one mapping). In one example, multiple CMRs can correspond to an PG (many-to-one mapping).

In one example, when the Pₜₒₜ antenna ports are co-located at one site, N_{g}=1. In one example, when the Pₜₒₜ antenna ports are distributed (non-co-located) across multiple sites, N_{g}>1.

In one example, when the Pₜₒₜ antenna ports are co-located at one site and within a single antenna panel, N_{g}=1. In one example, when the P_{CSIRS} antenna ports are distributed across multiple antenna panels (can be co-located or non-co-located), N_{g}>1.

The value of N_{g} can be configured, e.g. via higher layer RRC parameter. Or it can be indicated via a MAC CE. Or it can be provided via a DCI field.

Likewise, the value of K can be configured, e.g. via higher layer RRC parameter. Or it can be indicated via a MAC CE. Or it can be provided via a DCI field.

In one example, K=N_{g}=X. The value of X can be configured, e.g. via higher layer RRC parameter. Or it can be indicated via a MAC CE. Or it can be provided via a DCI field.

In one example, the value of K is determined based on the value of N_{g}. In one example, the value of N_{g} is determined based on the value of K.

The plurality of FD units can be associated with a frequency domain allocation of resources (e.g. one or multiple CSI reporting bands, each comprising multiple PRBs) and dimensionalizes the frequency (or delay)-domain profile of the channel measurement.

The plurality of TD units can be associated with a time domain allocation of resources (e.g. one or multiple CSI reporting windows, each comprising multiple time slots) and dimensionalizes the time (or Doppler)-domain profile of the channel measurement.

In one example, the number of antenna ports across K CMRs is the same. For example, each of the K CMRs can be associated with 2N₁N₂ antenna ports. In this case, the total number of antenna ports is P_{tot,K}=2KN₁N₂.

In one example, the number of antenna ports across K CMRs can be the same or different. For example, each of the K CMRs can be associated with ²N_{1,r}N_{2,r} antenna ports. In this case, the total number of antenna ports is

$${P}_{tot , K} = {\sum }_{r = 1}^{K} 2 {N}_{1 , r} {N}_{2 , r} .$$

In port numbering scheme 1, the CMR ports are numbered according to the order of (polarization p, CMR r) as CMR ports of (p=0, r=1) followed by CMR ports of (p=1, r=1), followed by CMR ports of (p=0, r=2), followed by CMR ports of (p=1, r=2), . . . , followed by CMR ports of (p=0, r=N) followed by CMR ports of (p=1, r=N).

In port numbering scheme 2, the CMR ports are numbered according to the order of (polarization p, CMR r) as
CMR ports of (p=0, r=1) followed by CMR ports of (p=0, r=1), . . . , followed by CMR ports of (p=0, r=N), and
then CMR ports of (p=1, r=1) followed by CMR ports of (p=1, r=1), . . . , followed by CMR ports of (p=1, r=N).

In one example, PGs can have a uniform (the same/common) structure. For example, they can have the same number of ports (P_{tot,r}=Pₜₒₜ) or the same antenna port layout (N_{1,r}, N_{2,r})=(N₁, N₂). In one example, PGs can have non-uniform (or different) structure. For example, they can have the same or different number of ports (P_{tot,r}_{₁}=_{tot,r}_{₂} or P_{tot,r}_{₁}≠_{tot,r}_{₂}) or the same antenna port layout, i.e., (N_{1,r}_{₁}, N_{2,r}_{₁})=(N_{1,r}_{₂}, N_{2,r}_{₂}) or (N_{1,r}_{ᵢ}, N_{2,r}_{₁})≠(N_{1,r}_{₂}, N_{2,r}_{₂}).

In one embodiment, a user is configured with a MIMO operation based on two steps:
1) NW configuring a UE to measure DL RSs associated with N_{g}≥1 ports or PGs
2) A reporting based on the measurement.

In one example, properties/assumptions associated with port(s) of the one or multiple PGs need to be established. Two main properties include: (a) QCL relation and (b) coherency. As for (a), it refers to channel properties that are common across ports associated with PGs, and (b) refers to transmission/reception hypothesis using multiple ports within/across PG(s). For QCL, relevant channel properties include (i) angular profile such as spatial filter parameter (analog beam), (ii) Delay profile such as average delay, delay spread, and (iii) Doppler profile such as Doppler shift, Doppler spread. Quasi co-location (QCL) assumptions correspond to LT channel properties that are common across antenna ports associated with PGs. A few examples of QCL relations are as follows:
{Doppler shift, Doppler spread, average delay, delay spread}
{Doppler shift, Doppler spread}
{Doppler shift, average delay}
{Spatial filter parameter}

The following are viable options for coherency.
Option 1: coherency based on new QCL-info or QCL-type (e.g. Type E) into the QCL or TCI-state definition
Option 2: coherency is separate from QCL-info or TCI state definition. It can be a dedicated IE or RRC parameter, e.g. coherency-Info.

A measurement and reporting to enable TCI state indication can be supported. Such reporting can be aperiodic: either NW-controlled (via DCI either UL-DCI or DL-DCI or a dedicated DCI, including two-stage DCI) or UE-initiated (e.g. UCI either PUCCH or PUSCH or dedicated layer 1 UL channel, including two-stage UCI). The UE-initiated can be based on an event detection.

Akin to NR UL codebook, the Coherency between/within PGs can be (1) full-coherence (FC), i.e., a layer (stream) is transmitted using antenna ports, (2) partial-coherence (PC), i.e., a layer (stream) is transmitted using at least two but not each of the antenna ports, or (3) non-coherence (NC), i.e., a layer (stream) is transmitted using one antenna port.

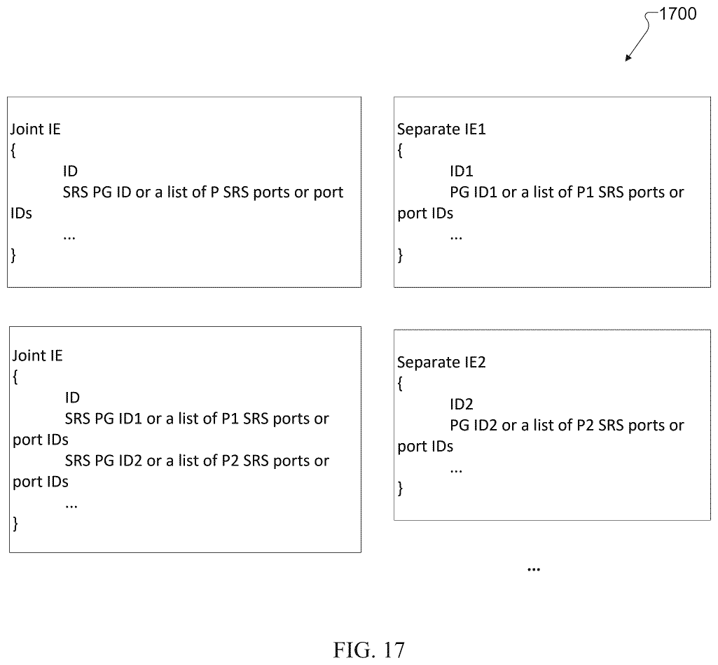

FIG. 17 illustrates a diagram of example SRS port information 1700 according to embodiments of the present disclosure. For example, SRS port information 1700 may be utilized by any of the UEs 111-116 of FIG. 1, such as the UE 111. This example is for illustration only and other embodiments can be used without departing from the scope of the present disclosure.

In one embodiment, a UE (e.g., the UE 116) is configured (e.g. via higher layer) with a UE assistance information (UAI) report, including an information (e.g. at least one indicator or parameter) about the imbalance or mismatch between n≥2 number of SRS transmission occasions (across different time slots). In one example, the UAI report is linked with a configuration in which the UE is configured with SRS transmission occasions associated (or configured via higher layer) with usage as ‘antennaSwitching’.

For xT yR UE, and x<y,
In one example, the value of n=y. Each SRS transmission is from 1 SRS port.
In one example, the value of

$$n = \frac{y}{x} .$$

Each SRS transmission is from x SRS ports.
In one example, when x does not divide y, the value of n can be

$$n = ⌈ \frac{y}{x} ⌉ .$$

Each of the n−1 SRS transmissions is from x SRS ports, and one SRS transmission from y mod x or y

$$- ⌊ \frac{y}{x} ⌋ x$$

SRS ports.

The UE can be configured with an information about SRS port(s) associated with each of the n SRS transmission occasions.
In one example, the information can be via a joint/single IE (cf. left examples in FIG. 17).
In one example, the information can be via n IEs, one for each SRS transmission occasion (cf. right example in FIG. 17).

In one example, the UAI report is to improve DL channel estimation accuracy based on SRS in a TDD system, e.g. the UAI report can be used to compensate imbalanced/mismatched SRS transmission power (or amplitude). The reported UAI may or may not reveal UE's antenna structure or any implementation. Note that this report can be in addition to (not a replacement or alterative of) DL/UL wideband/sub-band phase offset reporting to facilitate SRS-based DL precoding especially for (but not limited to) CJT scenarios across multiple TRPs or O-RUs or ports or PGs.

The content or report quantity of the UAI report can be according to at least one of following examples.
In one example, the content includes (at least one indicator or parameter to indicate) the absolute amplitude (aᵢ=\sqrt{pᵢ}) or power (pᵢ) of each Tx antenna port (i=1, . . . , y) at the UE. The number of reported quantities is y.
In one example, the content includes (at least one indicator or parameter to indicate) the absolute amplitude (aᵢ=\sqrt{pᵢ}) or power (pᵢ) of each SRS transmission occasion (i=1, . . . , n). The number of reported quantities is n.
In one example, the content includes (at least one indicator or parameter to indicate) the relative amplitude (aᵢ=\sqrt{pᵢ}) or power (pᵢ) of each of the y−1 Tx antenna ports (i=1, . . . , y and i≠i*), where the relative is w.r.t. a reference antenna port i*. The number of reported quantities is y-1.
In one example, the content includes (at least one indicator or parameter to indicate) the relative amplitude (aᵢ=\sqrt{pᵢ}) or power (pᵢ) of each of the n-1 SRS transmission occasions (i=1, . . . , n and i≠i*)), where the relative is w.r.t. a reference SRS transmission occasion i*. The number of reported quantities is n-1.
In one example, the relative amplitude or power (relative to a reference antenna port), reference can be fixed (e.g. first antenna port with lowest index) or configured or UE reported.
In one example, the content includes (at least one indicator or parameter to indicate) the absolute phase (ϕᵢ) in addition to the absolute amplitude (aᵢ=\sqrt{pᵢ}) or power (pᵢ) of each Tx antenna port or each SRS transmission occasions, as described herein.
In one example, the content includes (at least one indicator or parameter to indicate) the relative phase (ϕᵢ) in addition to the relative amplitude (aᵢ=\sqrt{pᵢ}) or power (pᵢ) of each Tx antenna port or each SRS transmission occasions, as described herein.

The reference antenna port or SRS transmission occasion i* can be fixed (e.g. first antenna port with lowest index) or configured (e.g. via higher layer) or reported by the UE (e.g. via the UAI report).

The range of imbalanced amplitude or power for the UAI report can be according to at least one of following examples.
In one example, the range corresponds to a normalized amplitude or power to be within [0,1]. The normalization can be w.r.t. a port or SRS transmission occasion (e.g. a strongest port or SRS transmission occasion). In one example, the value of the strongest/largest power or amplitude (that is used to normalize) is also reported together with the UAI report.
In one example, the range corresponds to amplitude or power within [a, b]. The value a or/and b can be fixed, configured (e.g. via higher layer) or reported by the UE.
In one example, the range may depend on device Types (e.g. handheld, customer premise equipment (CPE), fixed wireless access (FWA), Industrial).

The quantization of imbalanced amplitude or power within a range (cf. description herein) for the UAI report can be according to at least one of following examples.
In one example, the quantization is uniform in a linear scale.
   In one example, the quantization codebook corresponds to the b-bit amplitude codebook with quantization levels {f+δk: k=0,1, . . . , 2^{b}−1} where f is the first (smallest) quantization level/value (corresponding to k=0), and δ is the step size from the previous quantization level/value. In one example,

$$δ = \frac{Δ}{{2}^{b}} .$$

In one example,

$$f = \frac{Δ}{{2}^{b + 1}} .$$

In one example, Δ=b−a.
In one example, the quantization is uniform in a logarithmic (e.g. dB) scale.
   In one example, the quantization codebook corresponds to the 4-bit amplitude codebook for Rel-18 time-domain channel property (TDCP) reporting ([REF 9]).
   In one example, the quantization codebook corresponds to the 4-bit amplitude codebook for Rel-16 reference amplitude ([REF 9]).

When K>1 TRPs or PGs or O-RUs at the NW, and the UE is configured with SRS transmission occasions associated with (or for UL reception by) multiple TRPs or O-RUs or PGs, i.e. the SRS transmission occasions can be partitioned into K parts, one part associated with each of the K PGs or O-RUs, then the UAI report can be according to at least one of following examples.
In one example, the UAI report is separate (independent) for each of the K PGs or O-RUs. The K reports can be transmitted together in one slot (e.g. via UCI) and can be treated one joint report or K separate reports depending on the configuration of the UAI report.
In one example, the UAI report can include a subset of the K reports, where the information about the subset is provided (e.g. via higher layer) or reported by the UE (e.g. via the UAI report and e.g. via UCI part 1 of a two-part UCI).
In one example, the UAI report is joint (dependent) across the K PGs or O-RUs. For instance, the reference port or SRS transmission occasion or the normalization can be across the K PGs or O-RUs.

In one example, the associated between the SRS ports or SRS transmissions and a PG or O-RU at the NW can be fixed or configured via QCL or RRC IE (e.g. associated CSI-RS) or dynamically via DCI (e.g. via TCI state indication).

In one example, the UL channel for the UAI report can be according to at least one of following examples.
In one example, the UAI report is reported via a layer 1 (L1) UL channel carrying UCI (i.e. UAI is multiplexed or included in UCI). The L1 UL channel can be PUCCH or PUSCH or PRACH. In one example, for AP UAI report, the L1 UL channel is PUSCH. In one example, for periodic (P) UAI report, the L1 UL channel is PUCCH.
In one example, the UAI report is AP only and reported via PUSCH.
In one example, the UAI report is AP or semi-persistent (SP) and reported via PUSCH.
In one example, the UAI report is AP only and reported via PUCCH.
In one example, the UAI report is AP or semi-persistent (SP) and reported via PUCCH.
In one example, the UAI report is AP only and reported via PUSCH or PUCCH.
In one example, the UAI report is AP or semi-persistent (SP) and reported via PUSCH or PUCCH.
In one example, the UAI report is reported via a layer 2 (L2) UL channel (e.g. UL MAC CE). In one example, the UAI report is via power headroom report (PHR) reporting.

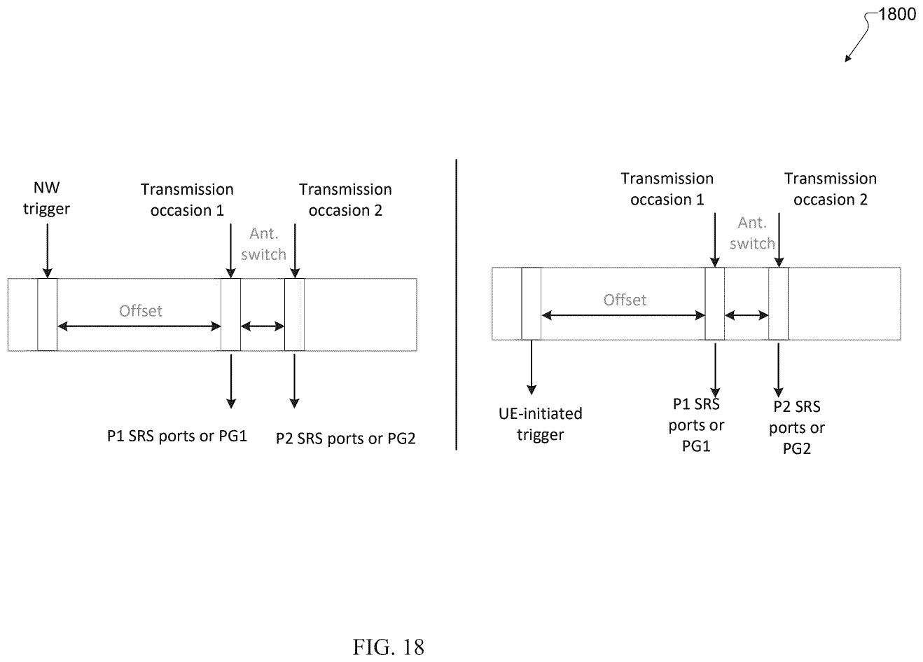

FIG. 18 illustrates a diagram of an example trigger 1800 for AP SRS transmission occasions 1800 according to embodiments of the present disclosure. For example, trigger 1800 can implemented by any of the UEs 111-116 in FIG. 1, such as the UE 116, and any of the BSs in FIG. 1, such as the BS 102. This example is for illustration only and other embodiments can be used without departing from the scope of the present disclosure.

In one example, the UAI report is reported after corresponding SRS transmission (occasions) for DL CSI acquisition based on antenna switching. In one example, the UAI report is associated with the most recent transmission of SRS for antennaSwitching which is transmitted before reporting UE assistance information.

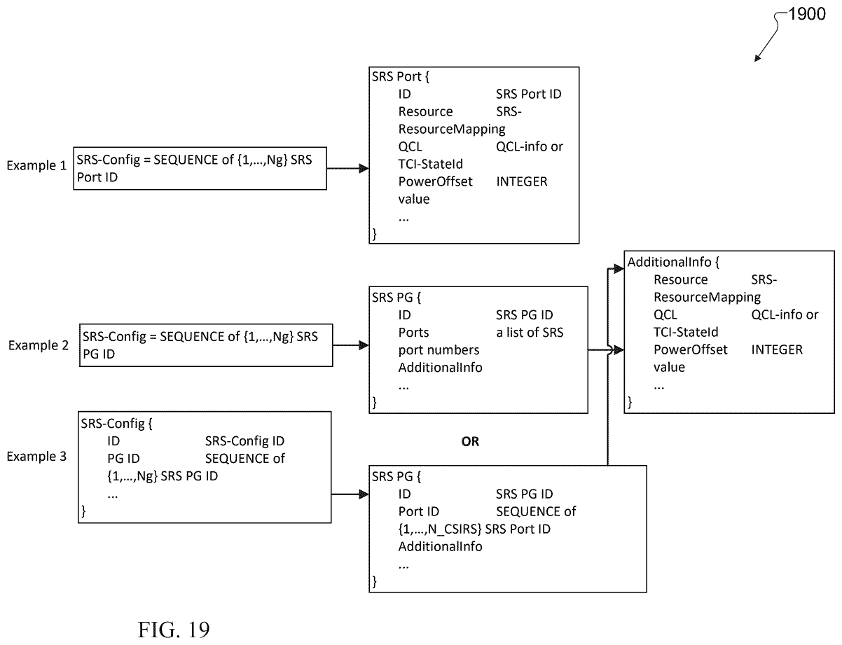

FIG. 19 illustrates a diagram of example SRS transmission configurations 1900 according to embodiments of the present disclosure. For example, SRS transmission configurations 1900 can be received by any of the UEs 111-116 of FIG. 1, such as the UE 116. This example is for illustration only and other embodiments can be used without departing from the scope of the present disclosure.

In one example, for AP SRS, a code point of a field in a DCI (e.g. UL-related DCI) can be used to trigger the AP SRS transmission occasions, where the offset between the time slot carrying the DCI with the trigger and the start (time slot for the first SRS transmission) is provided via SRS configuration (RRC) or the DCI. An example is shown in left side of FIG. 18.

In one example, for AP SRS, a UE-initiated trigger can be used to trigger the AP SRS transmission occasions, where the offset between the time slot carrying the DCI with the trigger and the start (time slot for the first SRS transmission) is provided via SRS configuration (RRC) or the DCI. An example is shown in right side of FIG. 18.

In one example, a configuration for SRS transmission includes at least one of the following:
In one example, a configuration for SRS transmission includes a list (or sequence) of SRS port IDs, where a SRS port ID indicates an information (e.g. IE) about a SRS port for transmission. Example 1 in FIG. 19 is an example.
In one example, a configuration for SRS transmission includes an SRS ID of a SRS PG (e.g. SRS PG ID) or a sequence of N_{g}≥1 SRS IDs (e.g. each is a SRS PG ID). Example 2 and 3 in FIG. 19 are two examples.
In one example, a configuration for SRS transmission includes a list of SRS port numbers (e.g. for SRS, port numbers are from {3000, 3001, 3002, . . . }).

In one embodiment, a UE is configured with a UAI report (as described herein) based on (or that is linked to) a DL measurement RS, where the DL measurement RS can be according to at least one of following examples
In one example, the DL measurement RS is a path-loss RS (PL-RS).
In one example, the DL measurement RS is a tracking RS (TRS) or NZP CSI-RS for tracking.
In one example, the DL measurement RS is a 1-port DL RS.
In one example, the DL measurement RS is a DMRS of a layer (e.g. layer 1)
In one example, the DL measurement RS is a DMRS of a layer where the layer is indicated via LI.

In one example, the PL-RS is provided/configured via a TCI state. The UE can be indicated with a TCI state via a DCI (e.g. DL-related DCI) or UL-related DCI. The TCI state can be a UL TCI state (for UL transmission) or a joint TCI state (for both DL and UL).

| | |
|---|---|
| TCI-State ::= | SEQUENCE { |
| tci-StateId | TCI-UL-StateId, |
| referenceSignal | CHOICE { |
| ssb-Index | SSB-Index, |
| csi-RS-Index | NZP-CSI-RS-ResourceId |

},

| | |
|---|---|
| pathlossReferenceRS-Id | PathlossReferenceRS-Id |

...
}

In one example, the PL-RS is provided/configured via an IE PathlossReferenceRS is used to configure a Reference Signal (e.g. a CSI-RS config or a SS block) to be used for path loss estimation for UL channel or RS (such as PUSCH, PUCCH and SRS).

| | |
|---|---|
| PathlossReferenceRS ::= | SEQUENCE { |
| pathlossReferenceRS-Id | PathlossReferenceRS-Id, |
| referenceSignal | CHOICE { |
| ssb-Index | SSB-Index, |
| csi-RS-Index | NZP-CSI-RS-ResourceId |

```
  },
  ...
}
```

In one example, the PL-RS is provided/configured via an IE SRS-Config.

| | |
|---|---|
| SRS-Config ::= | SEQUENCE { |
| srs-ConfigId | SRS-ConfigId, |
| srs-IdList | SEQUENCE (SIZE(1..maxNrofSRS-PerConfig)) OF SRS-Id |
| resourceType | CHOICE { |
| aperiodic | SEQUENCE { |
| aperiodicSRS-ResourceTrigger | INTEGER (1..maxNrofSRS-TriggerStates−1), |
| slotOffset | INTEGER (1..32) |

```
        ...
      },
      semi-persistent
      periodic
  },
```

| | |
|---|---|
| usage | ENUMERATED {antennaSwitching, ... ,}, |
| csi-RS | NZP-CSI-RS-Id |
| pathlossReferenceRS | PathlossReferenceRS-Config |

OR

| | |
|---|---|
| pathlossReferenceRSList | SetupRelease {PathlossReferenceRSList} |

..
}

| | |
|---|---|
| PathlossReferenceRS-Config ::= | CHOICE { |
| csi-RS-Index | NZP-CSI-RS-ResourceId |

}
OR

| | |
|---|---|
| PathlossReferenceRS-Config ::= | CHOICE { |
| ssb-Index | SSB-Index, |
| csi-RS-Index | NZP-CSI-RS-ResourceId |

}

| | |
|---|---|
| PathlossReferenceRSList ::= | SEQUENCE (SIZE (1..maxNrofSRS-PathlossReferenceRS)) OF |

PathlossReferenceRS

| | |
|---|---|
| PathlossReferenceRS ::= | SEQUENCE { |
| srs-PathlossReferenceRS-Id | SRS-PathlossReferenceRS-Id, |
| pathlossReferenceRS | PathlossReferenceRS-Config |

}

In one example, the PL-RS is provided/configured via an IE PUCCH-PathLossReferenceRS-Id, which is an ID for a RS configured as PUCCH pathloss.

In one example, the PL-RS is provided/configured via an IE PUSCH-PathLossReferenceRS-Id, which is an ID for a RS configured as PUSCH pathloss.

In one example, the PL-RS is provided/configured via an IE PUCCH-PowerControl, which is used to configure UE-specific parameter for the power control of PUCCH.

In one example, the PL-RS is provided/configured via an IE PUSCH-PowerControl, which is used to configure UE-specific parameter for the power control of PUSCH.

In one example, the PL-RS is provided/configured via an IE PUCCH-SpatialRelationInfo, which is used to configure the spatial setting (e.g. UL QCL) for PUCCH transmission.

In one example, the PL-RS is provided/configured via an IE PUSCH-SpatialRelationInfo, which is used to configure the spatial setting (e.g. UL QCL) for PUSCH transmission.

In one example, the PL-RS is provided/configured via an IE UL-TCIState, which is used to configure the spatial setting (e.g. UL QCL) for PUCCH or/and PUSCH or/and PRACH transmission.

In one example, the DL RS measurement is performed in one DL time slot for y Rx chains. In one example, the DL RS measurement is performed in multiple slots. For example, y/x antennae per slot. In one example, yj antennae in slot i such that y=Σᵢyᵢ.

In one example, for a NW-side duplex operation, a UE is configured with the UAI report as described herein, and also configured with SRS ports or SRS PGs or SRS transmission occasions, according to the following examples.
In one example, two separate SRS configurations (SRS1, SRS2) are configured.
   SRS1 corresponds to normal (non-duplex) MIMO operation.
   SRS2 correspond to duplex (e.g. SBFD).
In one example, one SRS configuration is provided.
   For normal (non-duplex), SRS channel measurement is used.
   For duplex (e.g. SBFD), SRS channel measurement is scaled, where the scaling depends on duplex parameter or measurements e.g. cross link interference (CLI) at the NW or O-RU.

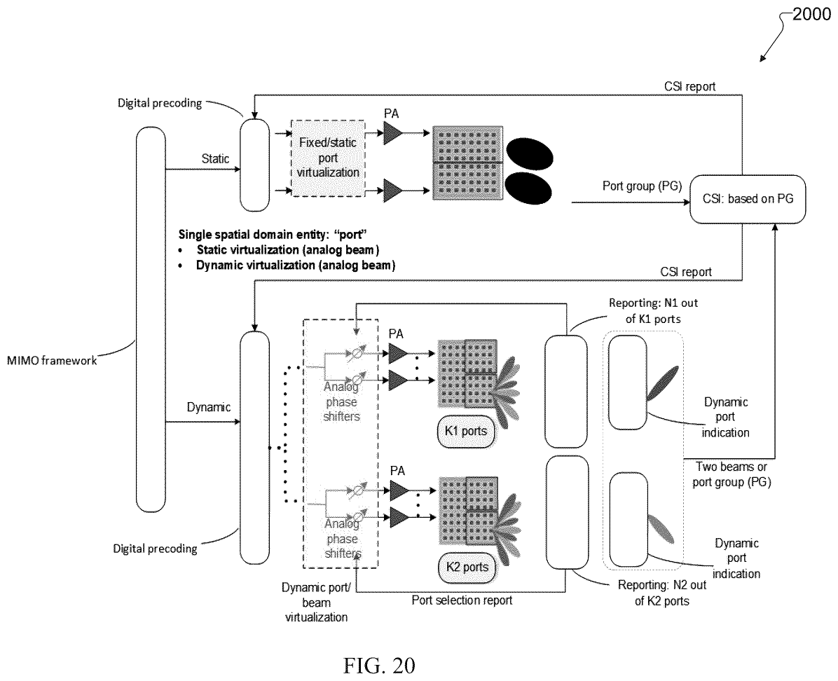

FIG. 20 illustrates a diagram of an example port group architecture 2000 according to embodiments of the present disclosure. For example, port group architecture 2000 can be implemented by the BS 102 of FIG. 2. This example is for illustration only and other embodiments can be used without departing from the scope of the present disclosure.

For the purpose of DL CSI acquisition, when necessary, a port group (PG) can be defined as a collection of N_{b}≥1 ports sharing a commonly configured set of properties (analogous to CSI-RS resource in 5G NR). This is instrumental in CSI reporting utilized for mTRP or multiple O-RUs (especially CJT) or virtual sectorization where a TRP or a O-RU or a virtual sector corresponds to a PG. Three key components of the framework are shown in FIG. 20.
C1: measurement and reporting to facilitate port selection/indication,
C2: dynamic indication of N port(s) out of K ports, and
C3: CSI reporting to enable digital precoding across a UE-recommended port group (PG).

In FR2 (i.e. in case of dynamic virtualization via analog beam), C1-C3 are utilized, and in FR1/FR3 (i.e., in case of fixed virtualization), only C3 is utilized. In the following, a PG is defined for FR1/FR3 (fixed virtualization case), not for FR2. In one example, PG is defined regardless of frequency band. An example FR1-FR3 are shown in Table 3.

TABLE 3

| Frequency range | Band |
|---|---|
| FR1 | Low band (<1 GHz) |
| FR1/FR3 | Lower mid band (1~7 GHz) |
| FR3 | Upper mid band (7~24) |
| FR2 | mmWave (>24 GHz) |

In one embodiment, a UE (e.g., the UE 116) is configured with a CSI report (e.g. trigger state or a CSI report setting via higher layer IE CSI-AperiodicTriggerState or CSI-ReportConfig) based on a port-based/PG-based framework, wherein the CSI report is based on a measurement configuration (e.g. CSI-ResourceConfig or CSI-MeasurementConfig or CSI-PGConfig or CSI-PortConfig).

The measurement configuration includes a configuration for channel measurement, which can be according to one of the following examples.
In one example, the channel measurement corresponds to measuring P_{CSIRS} CSI-RS ports.
In one example, the channel measurement corresponds to measuring N_{g}≥1 PGs, where a PG g=1 . . . , N_{g} includes P_{CSIRS,r} CSI-RS ports.
In one example, the channel measurement corresponds to measuring the Q_{CSIRS} ports or Mg PGs indicated dynamically (E.g. via DCI or/and MAC CE), where the Q_{CSIRS} ports or Mg PGs respectively are from the configured the P_{CSIRS} ports or N_{g} PGs. The dynamic indication can facilitate turning ports or PGs ON/OFF (e.g. for energy saving purpose).

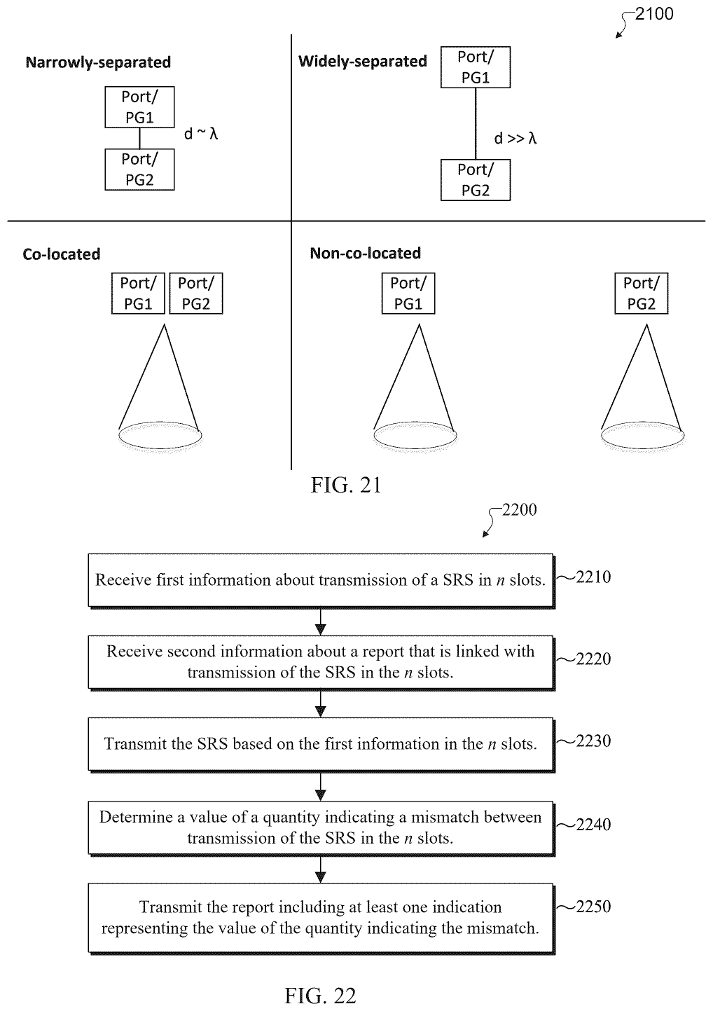

FIG. 21 illustrates a diagram of example co-located and non-co-located ports 2100 according to embodiments of the present disclosure. For example, co-located and non-co-located ports 2100 can be implemented in the wireless network 100 of FIG. 1. This example is for illustration only and can be used without departing from the scope of the present disclosure.

As shown in FIG. 21, the ports/PGs can be narrowly-spaced or widely-spaced with compared with the wavelength A of the (center) carrier of the frequency band associated with the CSI report. Or the ports/PGs can be col-located (at physical location) or non-co-located (at different physical locations).

The measurement configuration can also include a configuration for interference measurement.
In one example, the interference measurement corresponds to measuring I_{IMR} CSI-IMR ports. In one example, I_{IMR}=P_{CSIRS}. In one example, I_{IMR}=1.
In one example, the interference measurement corresponds to measuring I_{g}≥1 PGs, where a PGr=1 . . . , I_{g} includes I_{IMR,r} CSI-MR ports. In one example, I_{g}=N_{g}. In one example, I_{g}=1. In one example, I_{IMR,r}=P_{CSIRS,r}. In one example, I_{IMR,r}=1.

Any of the above variation embodiments can be utilized independently or in combination with at least one other variation embodiment.

FIG. 22 illustrates an example method 2200 performed by a UE in a wireless communication system according to embodiments of the present disclosure. The method 2200 of FIG. 22 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2200 is for illustration only and other embodiments can be used without departing from the scope of the present disclosure.

The method 2200 begins with the UE receiving first information about transmission of a SRS in n slots (2210). For example, in 2210, n≥2. In various embodiments, the first information includes a parameter usage set to ‘antennaSwitching’. The UE then receives second information about a report that is linked with transmission of the SRS in the n slots (2220). The UE then transmits the SRS based on the first information in the n slots (2230).

The UE then determines a value of a quantity indicating a mismatch between transmission of the SRS in the n slots (2240). For example, in 2240, the value of the quantity is determined based on the second information. In various embodiments, the UE includes x transmit and y receive antenna ports, where x≤y. For example, the quantity is relative to a reference slot or reference antenna port, the reference slot is one of the n slots, the reference antenna port is one of the x transmit antenna ports, and the reference slot or the reference antenna port is predetermined or configured. In another example, the quantity includes at least one of amplitude, power, and phase associated with each of the n slots or the x transmit antenna ports. In another example,

$$n = y or n = \frac{y}{x} ,$$

when n=y, transmission of the SRS in each of the n slots is from one of the x antenna ports, and when

$$n = \frac{y}{x} ,$$

transmission of the SRS in each of the n slots is from the x antenna ports.

The UE then transmits the report including at least one indication representing the value of the quantity indicating the mismatch (2250). In various embodiments, the UE receives a DL RS, the DL RS is one of a path-loss RS, a TRS, a CSI-RS, or a DMRS, the UE measures the DL RS, and the report is determined based on the measurement.

The above flowchart illustrates example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to:
receive first information about transmission of a sounding reference signal (SRS) in n slots, where n≥2,
receive second information about a report that is linked with transmission of the SRS in the n slots, and
transmit the SRS based on the first information in the n slots; and
a processor operably coupled to the transceiver, the processor configured to, based on the second information, determine a value of a quantity indicating a mismatch between transmission of the SRS in the n slots, and
wherein the transceiver is further configured to transmit the report including at least one indication representing the value of the quantity indicating the mismatch.

2. The UE of claim 1, wherein the first information includes a parameter usage set to ‘antennaSwitching’.

3. The UE of claim 1, wherein the transceiver includes x transmit and y receive antenna ports, where x≤y.

4. The UE of claim 3, wherein:
the quantity is relative to a reference slot or reference antenna port,
the reference slot is one of the n slots,
the reference antenna port is one of the x transmit antenna ports, and
the reference slot or the reference antenna port is predetermined or configured.

5. The UE of claim 3, wherein the quantity includes at least one of amplitude, power, and phase associated with each of the n slots or the x transmit antenna ports.

6. The UE of claim 3, wherein:
$$n = y or n = \frac{y}{x} ,$$
when n=y, transmission of the SRS in each of the n slots is from one of the x antenna ports, and
when
$$n = \frac{y}{x} ,$$
transmission of the SRS in each of the n slots is from the x antenna ports.

7. The UE of claim 1, wherein:
the transceiver is further configured to receive a downlink (DL) reference signal (RS),
the DL RS is one of a path-loss RS, a tracking RS (TRS), a channel state information-RS (CSI-RS), or demodulation RS (DMRS),
the processor is further configured to measure the DL RS, and
the report is determined based on the measurement.

8. A base station (BS) comprising:
a processor; and
a transceiver operably coupled to the processor, the transceiver configured to:
transmit, to a user equipment (UE), first information about transmission of a sounding reference signal (SRS) in n slots, where n≥2;
transmit second information about a report that is linked with transmission of the SRS in the n slots;
receive the SRS based on the first information in the n slots; and
receive the report including at least one indication representing a value of a quantity indicating a mismatch between the SRS in the n slots, wherein the report is based on the second information.

9. The BS of claim 8, wherein the first information includes a parameter usage set to ‘antennaSwitching’.

10. The BS of claim 8, wherein the UE includes x transmit and y receive antenna ports, where x≤y.

11. The BS of claim 10, wherein:
the quantity is relative to a reference slot or reference antenna port,
the reference slot is one of the n slots,
the reference antenna port is one of the x transmit antenna ports, and
the reference slot or the reference antenna port is predetermined or configured.

12. The BS of claim 10, wherein the quantity includes at least one of amplitude, power, and phase associated with each of the n slots or the x transmit antenna ports.

13. The BS of claim 10, wherein:
$$n = y or n = \frac{y}{x} ,$$
when n=y, reception of the SRS in each of the n slots is from one of the x antenna ports, and
when n
$$n = \frac{y}{x} ,$$
reception of the SRS in each of the n slots is from the x antenna ports.

14. The BS of claim 8, wherein:
the transceiver is further configured to transmit a downlink (DL) reference signal (RS),
the DL RS is one of a path-loss RS, a tracking RS (TRS), a channel state information-RS (CSI-RS), or demodulation RS (DMRS), and
the report is based on measurement of the DL RS.

15. A method performed by a user equipment (UE), the method comprising:
receiving first information about transmission of a sounding reference signal (SRS) in n slots, where n≥2;
receiving second information about a report that is linked with transmission of the SRS in the n slots;
transmitting the SRS based on the first information in the n slots;
based on the second information, determining a value of a quantity indicating a mismatch between transmission of the SRS in the n slots; and
transmitting the report including at least one indication representing the value of the quantity indicating the mismatch.

16. The method of claim 15, wherein the first information includes a parameter usage set to ‘antennaSwitching’.

17. The method of claim 15, wherein the UE includes x transmit and y receive antenna ports, where x≤y.

18. The method of claim 17, wherein:
the quantity is relative to a reference slot or reference antenna port,
the reference slot is one of the n slots,
the reference antenna port is one of the x transmit antenna ports, and
the reference slot or the reference antenna port is predetermined or configured.

19. The method of claim 17, wherein the quantity includes at least one of amplitude, power, and phase associated with each of the n slots or the x transmit antenna ports.

20. The method of claim 17, wherein:
$$n = y or n = \frac{y}{x} ,$$
when n=y, transmission of the SRS in each of the n slots is from one of the x antenna ports, and
when
$$n = \frac{y}{x} ,$$
transmission of the SRS in each of the n slots is from the x antenna ports.
